(19) United States
(12) Patent Application Publication
(10) Pub. No.: US 2026/0330197 A1
(43) Pub. Date: Oct. 22, 2026

(54) SYSTEM

(71) Applicant: SoftBank Group Corp., Tokyo (JP)

(72) Inventor: Shinichi TANAKA, Tokyo (JP)

(73) Assignee: SoftBank Group Corp., Tokyo (JP)

(21) Appl. No.: 19/650,381

(22) Filed: Apr. 17, 2026

(30) Foreign Application Priority Data
Apr. 22, 2025 (JP) 2025-070211

(51) Int. Cl. G06N 3/0475; G06N 3/042; G06N 3/0455

(52) U.S. Cl. CPC G06N 3/0475; G06N 3/042; G06N 3/0455

(57) ABSTRACT

The present invention relates to a future prediction platform that centrally integrates a wide variety of data, such as market trend data, consumer behavior data, technology development trend data, supply chain data, investment project data, and inventory data, collected from a plurality of business divisions and related companies, and realizes real-time and highly accurate future prediction and scenario simulation using generative AI. The generative AI automatically executes demand prediction, investment risk evaluation, technology trend extraction, resource allocation optimization, and the like, and a decision-making support unit automatically generates an optimal strategy plan and presents it to a user, thereby enabling integration of fragmented data, speeding up and optimization of decision-making, and company-wide competitiveness enhancement.

### CROSS-REFERENCE TO RELATED APPLICATION

The present application claims priority to and incorporates by reference the entire contents of Japanese Patent Application No. 2025-070211 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, because market trend data, consumer behavior data, technology development trend data, supply chain data, investment project data, inventory data, growth index data, and the like individually managed in a plurality of business divisions and related companies are fragmented, company-wide data integration is difficult, which makes it impossible to perform real-time market analysis and demand prediction, resulting in delays in decision-making, a decrease in prediction accuracy, and further inefficiencies such as excess and shortage in resource allocation such as investment and inventory management. In addition, there is also a problem that conventional analysis methods cannot predict market changes and demand fluctuations with high accuracy and speed, and data-driven decision-making necessary for strengthening competitiveness in the global market and creating new business opportunities has not been sufficiently realized. Furthermore, since data of each division is managed in different formats and standards, a great deal of labor and time are required for data standardization and preprocessing, and there is also a problem that an information infrastructure for management and field staff members to quickly select an optimal strategy is not developed. Therefore, in order to solve these problems, it is essential to centrally integrate a wide variety of fragmented data, realize real-time and highly accurate future prediction and scenario simulation utilizing generative AI, and automate and optimize decision-making such as resource allocation, investment judgment, and supply chain management based on the results.

### SUMMARY OF THE INVENTION

A means for solving the problem according to the present invention configures a system comprising a data integration unit, a generative AI processing unit, and a decision-making support unit, wherein the data integration unit is configured to centrally integrate heterogeneous and fragmented data, such as market trend data, consumer behavior data, technology development trend data, supply chain data, investment project data, inventory data, and growth index data, acquired from a plurality of business divisions and related companies such as communication, investment, energy, logistics, and marketing, based on time-series information and attribute information, and automatically execute preprocessing such as missing data complementation, standardization, normalization, and deduplication. The generative AI processing unit is configured to execute future predictions of market trends, demand fluctuations, technology trends, investment risks, growth potential, and the like in real time using a machine learning algorithm or a deep learning model with the integrated data as input, further automatically generate future predictions under a plurality of hypothetical conditions by a scenario simulation function, and continuously optimize a model in accordance with addition of new data by a self-learning function. The decision-making support unit is configured to automatically generate decision-making plans for resource allocation, investment judgment, inventory management, supply chain optimization, risk evaluation, and the like based on a future prediction result and a scenario simulation result by the generative AI processing unit, and present an optimal strategy proposal to a user, and by operating all of these processes using generative AI, integration of fragmented data, real-time and highly accurate future prediction, and speeding up and optimization of decision-making are realized.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

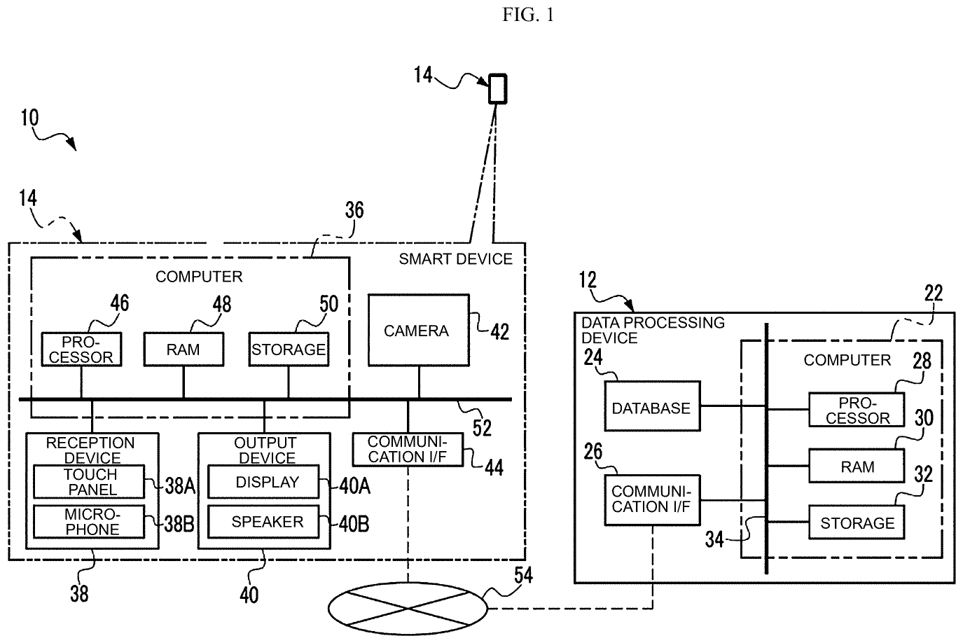

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

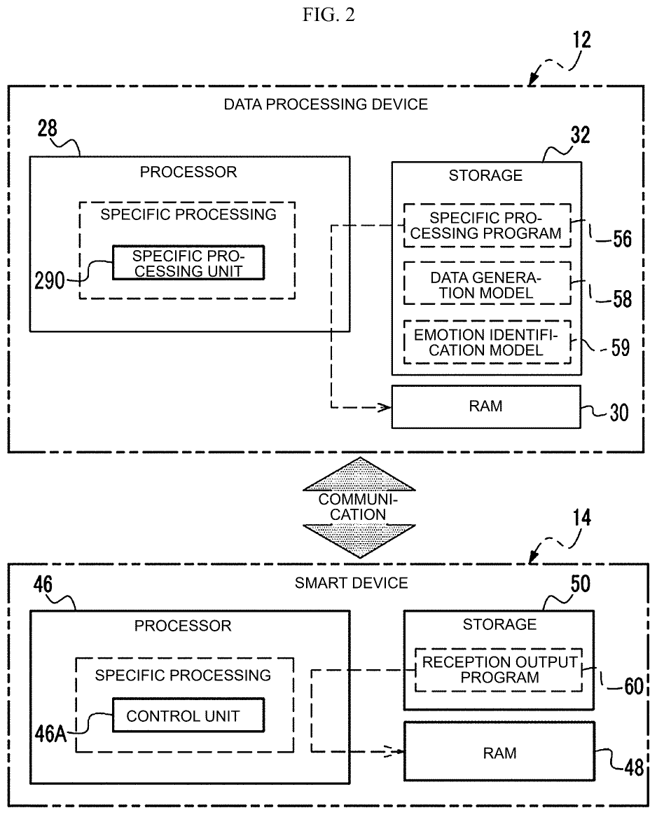

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail.

The system of the present invention is composed of a server and a terminal, wherein a data integration unit, a generative AI processing unit, a decision-making support unit, a log management unit, and a security management unit are implemented in the server, and a user interface unit, a notification receiving unit, and a local cache unit are implemented in the terminal. The server can be constructed in various forms such as a cloud infrastructure, an on-premises server, a virtual server, and a distributed server, and the terminal is composed of various devices such as a personal computer, a tablet, a smartphone, a wearable device, and a dedicated business terminal. Specifically, the present system adopts a distributed computing architecture. The server is composed of a plurality of computing nodes. Each computing node includes a multi-core processor and an accelerator for parallel computing. The server executes each processing unit as an independent microservice using container orchestration technology. The data integration unit communicates with an external system via an asynchronous messaging queue. The generative AI processing unit makes a large language model and a time-series prediction model resident on a memory. The decision-making support unit executes a heuristic search algorithm. The log management unit records an event record in an append-only distributed database. The security management unit manages an encryption key using a hardware security module. The terminal executes a web browser or a dedicated application. The user interface unit speeds up screen rendering using a virtual DOM. The notification receiving unit maintains a persistent connection with the server using a WebSocket protocol. The local cache unit constructs a key-value store in a non-volatile memory in the terminal. With this configuration, the present system realizes dynamic distribution of processing loads. The present system eliminates a single point of failure. The present system improves throughput in large-scale data processing. The present system minimizes communication delay. The present system is applicable to a transaction system of a financial institution and a supply chain management system of a large-scale manufacturing industry.

The data integration unit operates on the server and collects a wide variety of data, such as market trend data, consumer behavior data, technology development trend data, supply chain data, investment project data, inventory data, growth index data, financial data, SNS post data, news article data, patent data, paper data, weather data, traffic data, advertisement effect data, customer attribute data, purchase history data, equipment operation data, quality control data, and employee data, from a plurality of business divisions and related companies such as communication, investment, energy, logistics, marketing, manufacturing, sales, customer support, and research and development, by various means such as API linkage, file transfer (CSV, Excel, JSON, XML, etc.), database connection (SQL, NoSQL, etc.), IoT device linkage, external data provider linkage, and web scraping. For example, transitions in the number of subscribers, communication traffic, failure occurrence histories, and base station operation statuses are acquired from the communication division; financial statements of emerging companies, fundraising histories, manager attributes, and industry trends are acquired from the investment division; inventory amounts, delivery performance, warehouse operation rates, and delivery delay histories are acquired from the logistics division; power generation amounts, consumption amounts, equipment operation rates, and fuel prices are acquired from the energy division; advertisement placement histories, campaign effects, consumer questionnaire results, and reputations on SNS are acquired from the marketing division; the numbers of published papers, the numbers of patent applications, and technology evaluation scores are acquired from the research and development division; production amounts, equipment operation rates, and quality defect rates are acquired from the manufacturing division; sales transitions, customer attributes, and purchase histories are acquired from the sales division; and the numbers of inquiries, response histories, and customer satisfaction scores are acquired from the customer support division. Specifically, the data integration unit acquires data in parallel from a plurality of data sources using multi-thread processing. The data integration unit receives a payload in a JSON format via a RESTful API. The data integration unit converts a hierarchical structure in the payload into a flat two-dimensional table format. The data integration unit extracts a group of records from a relational database using an SQL query. The data integration unit loads the extracted group of records into an in-memory data grid. The data integration unit stream-receives time-series sensor data from an IoT device using an MQTT protocol. The data integration unit writes the received sensor data into a time-series database together with a time stamp. The data integration unit executes a web crawler to acquire an HTML document. The data integration unit analyzes a DOM tree to extract a specific text node. The data integration unit accumulates the extracted text node as a corpus for natural language processing. The data integration unit applies a hash function to each acquired data. The data integration unit verifies the presence or absence of data falsification using the calculated hash value. The data integration unit manages a different authentication token for each data acquisition source. The data integration unit monitors an expiration date of the token. The data integration unit automatically updates the token whose expiration date has passed. The data integration unit detects a network timeout and a connection error. The data integration unit executes a retry process using an exponential backoff algorithm when an error is detected. By this process, the present system automates data collection from heterogeneous data sources. The present system ensures comprehensiveness and real-time property of data collection. The present system prevents a decrease in accuracy of subsequent AI processing due to data loss. The present system is applicable to construction of an integrated data lake of a global company and a data collection infrastructure in a city OS of a smart city.

The data integration unit centrally integrates these data based on time-series information (year, month, day, hour, minute, second), attribute information (division, region, product, customer, equipment, project, etc.), and ID information (transaction ID, customer ID, product ID, etc.). As preprocessing of data, missing data complementation (mean complementation, regression complementation, time-series complementation, etc.), anomaly detection (statistical method, machine learning-based outlier detection, etc.), standardization of units and scales (z-score normalization, min-max scaling, etc.), deduplication of duplicate data, data type conversion (date type, numeric type, category type, etc.), data reliability evaluation (reliability of data source, acquisition date and time, data freshness, etc.), data anonymization and masking (personal information protection compliance), data encryption, and the like are automatically executed. For example, when the inventory data of the logistics division is managed on a daily basis and the sales data of the sales division is managed on a monthly basis, the daily data is aggregated into monthly data to unify the unit. Unstructured data such as SNS post data and news article data is converted into structured data by executing keyword extraction and sentiment analysis using a natural language processing model. Real-time data from an IoT device is stored in a time-series database by a stream processing infrastructure and integrated with other data. Specifically, the data integration unit executes schema mapping between heterogeneous data. The data integration unit converts a time stamp of each data record into coordinated universal time. The data integration unit synchronizes a plurality of data streams on a time axis based on the converted time stamp. The data integration unit specifies a record including a missing value. The data integration unit searches for a similar record using a k-nearest neighbor algorithm. The data integration unit complements the missing value using an attribute value of the similar record. The data integration unit executes an isolation forest algorithm to detect an outlier in a multidimensional space. The data integration unit assigns an anomaly flag to the detected outlier. The data integration unit applies a standardization process to numeric data such that a mean is zero and a variance is one. The data integration unit applies one-hot encoding to a categorical variable. The data integration unit converts the categorical variable into a multidimensional binary vector. The data integration unit adopts a pre-trained transformer architecture as a natural language processing model. The data integration unit divides text data into a token sequence. The data integration unit projects the token sequence into an embedding vector space. The data integration unit calculates a sentiment polarity score with the embedding vector as an input. The data integration unit assigns the calculated sentiment polarity score to the original text data as metadata. The data integration unit specifies a column including personal information. The data integration unit applies an irreversible hashing process to the specified column. The data integration unit converts the data after completion of the process into a multidimensional tensor format. The data integration unit stores the multidimensional tensor in a distributed file system. By this process, the present system converts raw data including noise and missing data into a high-quality input tensor processable by a machine learning model. The present system reduces a calculation cost required for preprocessing of data. The present system dramatically improves accuracy of subsequent inference processing. The present system is applicable to an integrated analysis platform for medical data and a quantitative analysis system for financial markets.

The generative AI processing unit operates on the server and utilizes generative AI as an essential element with the integrated data as an input. The generative AI is configured by combining a machine learning algorithm (random forest, gradient boosting, support vector machine, etc.), a deep learning model (LSTM, GRU, Transformer, CNN, etc.), a natural language processing model (large language model, BERT, GPT, etc.), a reinforcement learning model, an anomaly detection model, a clustering model, a regression model, a classification model, and the like. For example, a time-series prediction model such as LSTM or Transformer is used for demand prediction, and future demand is predicted with high accuracy using past demand data, seasonality, promotion information, weather data, economic indicators, and the like as inputs. A clustering or anomaly detection model is used for market trend analysis to perform market segmentation and detection of rapid changes. Regression analysis or a classification model is used for investment risk evaluation to evaluate growth potential, bankruptcy risk, fundraising success probability, and the like of an investment project from multiple angles. A natural language processing model is used for technology trend extraction to extract new technologies and fields of interest from text data such as paper databases, patent databases, news articles, and SNS posts. The generative AI automatically selects and combines these models to execute optimal prediction and analysis. For example, in demand prediction of the logistics division, past shipping data, seasonal fluctuations, promotion information, weather data, traffic data, disaster information, and the like are used as inputs, and the generative AI predicts an increase or decrease in demand with high accuracy. In the investment division, financial data of emerging companies, industry trends, competitor information, reputation data on SNS, manager backgrounds, past investment performance, and the like are integrated, and the generative AI evaluates growth potential and risk from multiple angles. In the technology development division, text data such as paper databases, patent databases, news articles, SNS posts, and technology blogs is analyzed by a natural language processing model to extract technology trends and research themes to be noted next. Based on these analysis results, the generative AI predicts future market trends, demand fluctuations, risk scenarios, growth potential, competitor trends, consumer preference changes, regulatory trends, and the like in real time. Furthermore, the generative AI has a scenario simulation function, and automatically generates future predictions under a plurality of hypothetical conditions set by a user, such as “when a new business is started”, “when a specific market grows rapidly”, “when logistics costs soar”, “when regulations are tightened”, “when raw material prices soar”, “when a natural disaster occurs”, and “when a competitor introduces a new product”. The generative AI also has a self-learning function, and automatically optimizes parameters and structures of a model by incorporating feedback from the user, new performance data, and external environment change data, thereby continuously improving prediction accuracy. For example, when a deviation between actual demand and a predicted value is large, cause analysis is automatically executed, and re-learning of the model and addition/deletion of feature amounts are automatically performed. Specifically, the generative AI processing unit adopts an ensemble learning architecture. The generative AI processing unit receives, as input data, a multidimensional tensor including monthly sales data for the past 120 months, a time-series array of weather data including temperature and precipitation, and a binary flag indicating the presence or absence of a promotion. The generative AI processing unit inputs this multidimensional tensor to a transformer model equipped with a self-attention mechanism. The transformer model learns a long-term dependency relationship between each time step of the input tensor. The transformer model generates a numeric vector indicating a predicted sales amount for the next 12 months as an output. The generative AI processing unit also receives a text string of a securities report of a company or a news article as text data. The generative AI processing unit inputs this text string to a large language model. The large language model is a deep neural network having billions of parameters. The large language model analyzes a context of the input text. The large language model generates a continuous value score from zero to one indicating a bankruptcy probability of the company and text data in natural language explaining a risk factor as an output. The generative AI processing unit transfers these output results to the subsequent decision-making support unit. The generative AI processing unit executes a Monte Carlo method in scenario simulation. The generative AI processing unit samples a random number from a probability distribution based on the input hypothetical condition. The generative AI processing unit generates thousands of patterns of future scenarios using the sampled random number. The generative AI processing unit calculates an expected return in each scenario. The generative AI processing unit executes a backpropagation algorithm to minimize a prediction error. The generative AI processing unit uses a mean squared error as a loss function. The generative AI processing unit iteratively updates a weight parameter of the neural network using a gradient descent method. By this process, the present system realizes data-driven, highly accurate future prediction that does not depend on human intuition. The present system models a complex non-linear relationship. The present system quantifies uncertainty of prediction. The present system is applicable to a dynamic pricing system of a retail business and a dynamic risk evaluation system of an insurance company.

The decision-making support unit operates on the server and automatically generates decision-making plans for resource allocation, investment judgment, inventory management, supply chain optimization, risk evaluation, project prioritization, capital investment planning, personnel allocation planning, advertisement budget allocation, price strategy formulation, customer targeting, campaign optimization, quality improvement proposal, equipment maintenance planning, and the like based on a future prediction result and a scenario simulation result by the generative AI processing unit. For example, in the logistics division, an optimal additional order amount, delivery plan, inventory movement plan, and emergency countermeasure are automatically calculated in consideration of predicted demand, a current inventory amount, warehouse capacity, delivery cost, lead time, weather risk, traffic conditions, and the like. In the investment division, an investment amount, investment timing, an investment recovery scenario, a risk diversification plan, and a withdrawal criterion are automatically proposed for a field or company expected to grow. In the energy division, optimal energy allocation, a procurement plan, a supply and demand adjustment plan, and a renewable energy introduction plan are automatically generated based on power generation amount prediction, consumption amount prediction, fuel prices, equipment operation rates, supply and demand balance, and regulatory trends. In the marketing division, an optimal promotion strategy, advertisement budget allocation, a targeting plan, a product price setting plan, and a campaign schedule plan are automatically proposed based on consumer behavior prediction, advertisement effect analysis, competitor trends, seasonality, and promotion histories. In the manufacturing division, a production plan, a raw material order plan, a quality improvement plan, and an equipment maintenance plan are automatically generated based on demand prediction, production capacity, equipment operation rates, raw material inventory, quality defect rates, and delivery date constraints. The decision-making support unit visualizes these decision-making plans in an easy-to-understand manner for the user, and presents a plurality of options, risk evaluation, expected return, cost, feasibility, scenario comparison, and the like on a dashboard. Furthermore, when the user adopts or modifies the decision-making plan, the result and feedback are automatically fed back to the generative AI processing unit, thereby continuously realizing an accuracy improvement of the model and an optimization of decision-making. For example, when the user adopts the proposed inventory optimization plan and actual inventory cost is reduced, the generative AI learns the performance data to improve future proposal accuracy. Specifically, the decision-making support unit incorporates a mathematical optimization solver. The decision-making support unit receives the numeric vector of the predicted sales amount, the continuous value score of the bankruptcy probability, and the expected return of each scenario output from the generative AI processing unit. The decision-making support unit sets these input values as coefficients of an objective function. The decision-making support unit formulates a budget upper limit, a personnel constraint, and an upper limit of an equipment operation rate as constraint conditions. The decision-making support unit executes a mixed integer linear programming algorithm. The decision-making support unit searches for an optimal solution that maximizes or minimizes the objective function. The decision-making support unit outputs an integer vector indicating an optimal inventory replenishment amount to each base as the optimal solution. The decision-making support unit also executes a reinforcement learning agent. The reinforcement learning agent interacts with an environment model based on a Markov decision process. The reinforcement learning agent observes a current inventory state as a state vector. The reinforcement learning agent selects an ordering action as an action vector. The reinforcement learning agent receives a negative value of a sum of an out-of-stock penalty and a storage cost as a reward. The reinforcement learning agent updates an action-value function using a Q-learning algorithm. The decision-making support unit converts the optimized action vector into specific business instruction data. The decision-making support unit formats the business instruction data in a JSON format. The decision-making support unit transmits the formatted data to the user interface unit. The decision-making support unit records a final decision-making result selected by the user on the dashboard as a log. The decision-making support unit supplies this log data as training data to a re-learning pipeline of the generative AI processing unit. By this process, the present system instantaneously derives a mathematically supported optimal solution from a vast number of combinations. The present system realizes multi-objective optimization exceeding human cognitive limits. The present system dramatically improves business efficiency. The present system is applicable to a flight schedule optimization system of an airline company and an automatic vehicle dispatching system of a large-scale logistics center.

The log management unit operates on the server and records and manages detailed logs of all data acquisition, preprocessing, learning/inference of AI models, decision-making plan generation, user operations, feedback, system errors, security events, and the like in chronological order. This enables system traceability, audit response, failure analysis, operation improvement, and compliance response. Specifically, the log management unit adopts an asynchronous event-driven architecture. The log management unit receives a log message output from each processing unit via a message broker. The log management unit parses the received log message. The log management unit extracts a time stamp, an event type, a user identifier, and a processing result code from the log message. The log management unit converts the extracted data into a structured JSON object. The log management unit indexes and stores this JSON object in a distributed search engine. The log management unit applies blockchain technology to prevent falsification of log data. The log management unit compiles a batch of log records at regular time intervals. The log management unit calculates a cryptographic hash value of the entire batch. The log management unit generates a new hash value by concatenating this hash value with a hash value of a previous batch. The log management unit records this chained hash structure in a non-volatile storage. The log management unit monitors a retention period of log data. The log management unit automatically archives old log data whose legal retention period has passed to a cold storage. The log management unit executes a rule-based engine for detecting log output of an abnormal pattern. The log management unit fires an alert event when an error rate exceeds a threshold value. By this process, the present system ensures a complete audit trail. The present system speeds up root cause analysis when a failure occurs. The present system guarantees transparency and reliability of the system. The present system is applicable to an electronic medical record access monitoring system of a medical institution and a transaction audit system of a financial institution.

The security management unit operates on the server and comprehensively implements data encryption, access authority management, user authentication, communication path encryption, unauthorized access detection, malware countermeasures, data backup, disaster recovery response, personal information protection response, and the like. For example, highly confidential investment project data and customer data including personal information are subjected to strong encryption both during storage and during transfer, and access authority is strictly controlled. Specifically, the security management unit executes access control based on a zero-trust network architecture. The security management unit requests identity verification for all communication requests from the outside and the inside. The security management unit encrypts a communication payload using a public key cryptography method. The security management unit encrypts stored data in a database using an advanced encryption standard algorithm. The security management unit automatically manages generation, rotation, and destruction of an encryption key. The security management unit holds a role-based access control list on a memory. The security management unit verifies whether an operation requested by a user is permitted in the access control list. The security management unit executes an intrusion detection system that monitors network traffic. The security management unit analyzes a header and a payload of a packet. The security management unit performs pattern matching with a known attack signature. The security management unit executes a machine learning-based behavior detection algorithm. The security management unit identifies an abnormal traffic flow deviating from a normal communication pattern. The security management unit automatically blocks communication from a corresponding IP address with a firewall when an anomaly is detected. The security management unit periodically acquires a snapshot of the entire system. The security management unit asynchronously transfers the snapshot to a geographically distant backup data center. By this process, the present system minimizes a data leakage risk due to a cyberattack. The present system prevents data removal due to internal fraud. The present system ensures business continuity. The present system is applicable to a confidential information management system of a government agency and a supply chain protection system of a defense industry.

The user interface unit is implemented on the terminal side, and the user can access the server from the terminal and operate a dashboard, a report, a scenario setting screen, a decision-making plan presentation screen, a feedback input screen, a notification receiving screen, a history reference screen, a report output screen, an alert receiving screen, and the like. For example, a management layer can overlook company-wide market trends and risk scenarios from the terminal, and a field staff member can confirm demand prediction and an inventory optimization plan of his/her own division, change scenario conditions as necessary, and input feedback to the decision-making plan. On the terminal side, user authentication, access authority management, a notification function, a report output function, high-speed display by a local cache, temporary storage during offline, securing of a secure communication path, and the like are also implemented. Specifically, the user interface unit is constructed as a single-page application. The user interface unit receives data in a JSON format from the server by asynchronous communication. The user interface unit stores the received data in a state management library on a client side. The user interface unit dynamically generates an HTML element based on this state data. The user interface unit renders multidimensional data as an interactive graph or chart using a data visualization library. The user interface unit captures an input event such as a user's click or swipe. The user interface unit immediately updates display contents in accordance with the input event. The user interface unit provides a slider and a drop-down menu on the scenario setting screen. The user interface unit transmits a parameter changed by the user to the server in real time. The user interface unit reflects a recalculation result returned from the server on the screen. The user interface unit provides a text input field in natural language on the feedback input screen. The user interface unit formats the input text as data for re-learning of a natural language processing model. The user interface unit executes a service worker. The user interface unit stores a static asset and an API response in a cache storage of a browser. The user interface unit reads data from the cache and maintains offline display when network disconnection is detected. By this process, the present system reduces a waiting time of the user. The present system provides intuitive operability. The present system improves a user experience of a decision-making process. The present system is applicable to a production management dashboard of a factory and a mobile inventory management application of a store.

As described above, in the embodiment of the present invention, data integration, future prediction/scenario simulation/self-learning by generative AI, decision-making support, log management, and security management are centrally and automatically executed on the server side, and various user interfaces are provided on the terminal side, thereby realizing integration of fragmented data, real-time and highly accurate future prediction, prompt and optimal decision-making support, and safety, reliability, and expandability of system operation. The generative AI plays an essential role in all main processes of data preprocessing, feature amount extraction, model selection, prediction/analysis, scenario generation, self-learning, decision-making plan generation, and feedback learning, and enables advanced data utilization and automation/optimization of decision-making that could not be realized by conventional methods. For example, it is a major feature of the present invention that the generative AI plays a core role in all business areas, such as the AI automatically analyzing market trends, generating an inventory optimization plan for the logistics division, proposing a risk diversification strategy for the investment division, creating a supply and demand adjustment plan for the energy division, optimizing advertisement budget allocation for the marketing division, automatically generating a production plan for the manufacturing division, and presenting a company-wide optimal strategy to the management layer on a dashboard. Specifically, the present system pipelines a data flow between each processing module. The present system arranges the multidimensional tensor output from the data integration unit in a shared memory space. The present system permits the generative AI processing unit to read data from this shared memory space with zero copy. The present system writes a result vector inferred by the generative AI processing unit into the shared memory space again. In the present system, the decision-making support unit immediately acquires this result vector and executes an optimization algorithm. The present system completes this series of processes with a latency in milliseconds. The present system applies an online learning algorithm in a self-learning process of the generative AI. The present system incrementally updates a weight of a neural network every time a new data stream arrives. The present system levels a spike in calculation resources accompanying batch learning. The present system prevents obsolescence of a model. The present system hierarchically integrates a plurality of sub-models specialized for each business area. The present system performs weighted addition of outputs of each sub-model using a meta-learner. The present system derives a global optimal solution that maximizes a company-wide key performance indicator. By this process, the present system integrates siloed business processes in a data-driven manner. The present system fundamentally transforms a conventional decision-making process depending on human rules of thumb. The present system dramatically enhances competitiveness of a company. The present system is applicable to a global business management system of a multinational company and an autonomous control platform of a smart factory. (System Configuration)

The system according to the present embodiment comprises a data integration unit, a generative AI processing unit, a decision-making support unit, a log management unit, a security management unit, a user interface unit, a notification receiving unit, and a local cache unit. The data integration unit collects a wide variety of data, such as market trend data, consumer behavior data, technology development trend data, supply chain data, investment project data, inventory data, growth index data, financial data, SNS post data, news article data, patent data, paper data, weather data, traffic data, advertisement effect data, customer attribute data, purchase history data, equipment operation data, quality control data, and employee data, from a plurality of business divisions and related companies such as communication, investment, energy, logistics, marketing, manufacturing, sales, customer support, and research and development, by various means such as API linkage, file transfer, database connection, IoT device linkage, external data provider linkage, and web scraping. For example, transitions in the number of subscribers, communication traffic, failure occurrence history, and base station operation status are acquired from the communication division; financial statements, fund procurement history, manager attributes, and industry trends of emerging companies are acquired from the investment division; inventory amounts, delivery performance, warehouse operation rates, and delivery delay history are acquired from the logistics division; power generation amounts, consumption amounts, equipment operation rates, and fuel prices are acquired from the energy division; advertisement placement history, campaign effects, consumer questionnaire results, and reputations on SNS are acquired from the marketing division; the number of paper publications, the number of patent applications, and technology evaluation scores are acquired from the research and development division; production amounts, equipment operation rates, and quality defect rates are acquired from the manufacturing division; sales transitions, customer attributes, and purchase history are acquired from the sales division; and the number of inquiries, response history, and customer satisfaction scores are acquired from the customer support division. The data integration unit centrally integrates these data based on time-series information, attribute information, and ID information, and automatically executes preprocessing such as missing data complementation, anomaly detection, standardization of units and scales, deduplication of data, data type conversion, data reliability evaluation, data anonymization/masking, and data encryption. For example, when the inventory data of the logistics division is managed on a daily basis and the sales data of the sales division is managed on a monthly basis, the daily data is aggregated into monthly data to unify the unit. Unstructured data such as SNS post data and news article data is converted into structured data by executing keyword extraction and sentiment analysis using a natural language processing model. Real-time data from IoT devices is stored in a time-series database by a stream processing infrastructure and integrated with other data. Specifically, the data integration unit operates based on a distributed streaming platform. The data integration unit partitions an input stream from each data source. The data integration unit reads data in parallel using a plurality of consumer processes. The data integration unit converts the read data into a data frame on a memory. The data integration unit applies a vectorized operation to this data frame. The data integration unit executes downsampling and upsampling of time-series data. The data integration unit estimates a value of a missing time step using a spline interpolation algorithm. The data integration unit executes principal component analysis to compress a feature space of high-dimensional data into a low dimension. The data integration unit generates a compressed feature vector. The data integration unit executes morphological analysis on text data. The data integration unit calculates a TF-IDF vector based on an appearance frequency of a word. The data integration unit uses this vector as an input for cosine similarity calculation. When image data is included, the data integration unit extracts a feature map from an image using a convolutional neural network. The data integration unit flattens the extracted feature map into a one-dimensional vector. The data integration unit combines all of these preprocessed data into a single multidimensional tensor. The data integration unit serializes this tensor in a column-oriented data format. By this processing, the system efficiently processes petabyte-class big data. The system eliminates a preprocessing bottleneck of data. The system improves a learning convergence speed of a subsequent machine learning model. The system is applicable to a sensor data integration system of an autonomous vehicle and a power grid monitoring system of a smart grid.

The generative AI processing unit receives the integrated and preprocessed diverse data from the data integration unit, utilizes generative AI as an essential element, and executes future prediction, scenario simulation, and self-learning by combining a machine learning algorithm, a deep learning model, a natural language processing model, a reinforcement learning model, an anomaly detection model, a clustering model, a regression model, a classification model, and the like. For example, for demand prediction, a time-series prediction model such as LSTM or Transformer is used to predict future demand with high accuracy using past demand data, seasonality, promotion information, weather data, economic indicators, and the like as input. For market trend analysis, a clustering or anomaly detection model is used to perform market segmentation and detection of rapid changes. For investment risk evaluation, a regression analysis or classification model is used to evaluate growth potential, bankruptcy risk, fund procurement success probability, and the like of an investment project from multiple angles. For technology trend extraction, a natural language processing model is used to extract new technologies and fields of interest from text data such as paper databases, patent databases, news articles, and SNS posts. The generative AI automatically selects and combines these models to execute optimal prediction and analysis. For example, in demand prediction of the logistics division, past shipping data, seasonal fluctuations, promotion information, weather data, traffic data, disaster information, and the like are used as input, and the generative AI predicts an increase or decrease in demand with high accuracy. In the investment division, financial data, industry trends, competitor information, reputation data on SNS, manager backgrounds, past investment performance, and the like of emerging companies are integrated, and the generative AI evaluates growth potential and risk from multiple angles. In the technology development division, text data such as paper databases, patent databases, news articles, SNS posts, and technology blogs is analyzed by a natural language processing model to extract technology trends and research themes to be noted next. Based on these analysis results, the generative AI predicts future market trends, demand fluctuations, risk scenarios, growth potential, competitor trends, consumer preference changes, regulatory trends, and the like in real time. Furthermore, the generative AI has a scenario simulation function, and automatically generates future predictions under a plurality of hypothetical conditions set by a user, such as “when a new business is started,” “when a specific market grows rapidly,” “when logistics costs soar,” “when regulations are strengthened,” “when raw material prices soar,” “when a natural disaster occurs,” and “when a competitor introduces a new product.” The generative AI also has a self-learning function, and automatically optimizes parameters and a structure of a model by incorporating feedback from a user, new performance data, and external environment change data, thereby continuously improving prediction accuracy. For example, when a divergence between actual demand and a predicted value is large, cause analysis is automatically executed, and relearning of the model and addition/deletion of feature amounts are automatically performed. Specifically, the generative AI processing unit is executed on a parallel computing cluster using GPUs. The generative AI processing unit receives, as input data, a one-dimensional array indicating past sales performance, an embedding vector of a categorical variable indicating a product attribute, and a binary flag indicating a promotion period. The generative AI processing unit combines these inputs and inputs them to a multilayer perceptron. The multilayer perceptron uses a ReLU function as a nonlinear activation function. The multilayer perceptron learns high-order interactions of feature amounts in a hidden layer. The generative AI processing unit generates, as an output, a vector of continuous values indicating the predicted number of sales of each product for the next week. The generative AI processing unit also receives a character string of a customer review comment as text data. The generative AI processing unit inputs this character string to a pre-trained language model. The language model assigns a high weight to an important word in a sentence using an attention mechanism. The language model generates, as an output, a probability score from zero to one indicating a positive degree of the review. The generative AI processing unit transmits this probability score to a threshold determination module. The threshold determination module sets an alert flag when the score is equal to or less than a certain value. The generative AI processing unit calculates a difference between a predicted value and a performance value in self-learning. The generative AI processing unit backpropagates this difference as an error signal through a network. The generative AI processing unit updates weights while dynamically adjusting a learning rate using an Adam optimizer. By this processing, the system recognizes a complex pattern that cannot be handled by a static rule-based system. The system autonomously adapts to environmental changes. The system continuously improves prediction accuracy. The system is applicable to an algorithmic trading system of a financial institution and a personalized recommendation system of an e-commerce site.

The decision-making support unit automatically generates decision-making plans for resource allocation, investment judgment, inventory management, supply chain optimization, risk evaluation, project prioritization, capital investment planning, personnel allocation planning, advertisement budget allocation, price strategy formulation, customer targeting, campaign optimization, quality improvement proposal, equipment maintenance planning, and the like based on a future prediction result and a scenario simulation result by the generative AI processing unit. For example, in the logistics division, an optimal additional order amount, delivery plan, inventory movement plan, and emergency countermeasure are automatically calculated in consideration of predicted demand, current inventory amount, warehouse capacity, delivery cost, lead time, weather risk, traffic conditions, and the like. In the investment division, an investment amount, investment timing, investment recovery scenario, risk diversification plan, and withdrawal criteria are automatically proposed for fields and companies expected to grow. In the energy division, optimal energy allocation, procurement plan, supply and demand adjustment plan, and renewable energy introduction plan are automatically generated based on power generation amount prediction, consumption amount prediction, fuel prices, equipment operation rates, supply and demand balance, and regulatory trends. In the marketing division, an optimal promotion strategy, advertisement budget allocation, targeting plan, product pricing plan, and campaign schedule plan are automatically proposed based on consumer behavior prediction, advertisement effect analysis, competitor trends, seasonality, and promotion history. In the manufacturing division, a production plan, raw material order plan, quality improvement plan, and equipment maintenance plan are automatically generated based on demand prediction, production capacity, equipment operation rates, raw material inventory, quality defect rates, and delivery date constraints. The decision-making support unit visualizes these decision-making plans in an easy-to-understand manner for a user, and presents a plurality of options, risk evaluation, expected revenue, cost, feasibility, scenario comparison, and the like on a dashboard. Furthermore, when the user adopts or modifies a decision-making plan, the result and feedback are automatically fed back to the generative AI processing unit, thereby continuously realizing an accuracy improvement of the model and an optimization of decision-making. For example, when the user adopts a proposed inventory optimization plan and actual inventory costs are reduced, the generative AI learns the performance data to improve future proposal accuracy. Specifically, the decision-making support unit models a network structure of a supply chain using a graph neural network. The decision-making support unit constructs graph structure data with each warehouse or factory as a node and a transportation route as an edge. The decision-making support unit receives a predicted demand amount vector of each node output from the generative AI processing unit. The decision-making support unit inputs this predicted demand amount vector to the graph neural network as a feature amount of the node. The graph neural network executes a message passing algorithm. The graph neural network propagates information between adjacent nodes. The graph neural network generates, as an output, a tensor of continuous values indicating an optimal transportation amount at each edge. The decision-making support unit uses this tensor as an initial solution for a constraint satisfaction problem. The decision-making support unit further improves the initial solution using a local search method. The decision-making support unit generates a specific truck dispatch schedule and a list of load capacities as a final optimal solution. The decision-making support unit outputs this list as structured JSON data. The decision-making support unit transmits this JSON data to a subsequent automatic dispatch system via an API. When the user selects one from a plurality of options presented on the dashboard, the decision-making support unit records the selection behavior as a log. The decision-making support unit converts this selection log as a reward signal for reinforcement learning. The decision-making support unit feeds back this reward signal to the generative AI processing unit. By this processing, the system achieves overall optimization while satisfying complexly intertwined constraint conditions. The system solves a combinatorial optimization problem of a scale impossible for human calculation ability within a realistic time. The system significantly reduces logistics costs. The system is applicable to a traffic flow optimization system of a smart city and a smart grid control system of a wide-area power grid.

The log management unit records and manages detailed logs of all data acquisition, preprocessing, learning/inference of AI models, decision-making plan generation, user operations, feedback, system errors, security events, and the like in chronological order. This enables system traceability, audit response, failure analysis, operation improvement, and compliance response. For example, version management of AI models, data acquisition date and time, user decision-making history, detailed logs at the time of system failure occurrence, access history from the outside, and the like are recorded in detail. Specifically, the log management unit deploys a log data collection agent to each server node. The collection agent monitors standard output and standard error output of an operating system. The collection agent tails a log file generated by an application in real time. The collection agent accumulates collected raw log data in a buffer on a memory. The collection agent collectively transmits the log data to a central log aggregation server when the buffer reaches a certain size. The log aggregation server executes pattern matching using a regular expression on the received log data. The log aggregation server extracts an IP address, a user ID, and an error code from the log data. The log aggregation server inserts the extracted data into a columnar format database. The log management unit periodically issues an aggregation query to the database. The log management unit calculates an occurrence frequency of a specific error code. The log management unit generates an anomaly detection event when the occurrence frequency exceeds a preset threshold. The log management unit push-notifies this event to a monitoring dashboard. The log management unit records a hash value of an input tensor, a version ID of a used model, and a value of an output vector as an inference log of an AI model. By this processing, the system ensures reproducibility of an inference result of the model. The system detects accuracy degradation of the model at an early stage. The system continuously monitors soundness of the system. The system is applicable to an observability infrastructure of a cloud-native application and a distributed tracing system of a large-scale microservice architecture.

The security management unit comprehensively implements data encryption, access authority management, user authentication, communication path encryption, unauthorized access detection, malware countermeasures, data backup, disaster recovery response, personal information protection response, and the like. For example, highly confidential investment project data and customer data including personal information are subjected to strong encryption both during storage and transfer, and access authority is strictly controlled. When unauthorized access from the outside or an abnormal operation is detected, an administrator is immediately notified, and access blocking and data isolation are automatically executed as necessary. Specifically, the security management unit implements a multi-factor authentication protocol. The security management unit requests input of a one-time password in response to a user login request. The security management unit verifies signature data from a biometric authentication device. The security management unit issues a short-lived JSON web token to a successfully authenticated user. The security management unit authorizes a subsequent API request using this token. The security management unit enables a transparent data encryption function of a database. The security management unit executes encryption processing at a block level immediately before data is written to a disk. The security management unit automatically executes decryption processing when data is read into a memory. The security management unit deploys a web application firewall at a network boundary. The security management unit inspects a header and a body of an HTTP request. The security management unit detects a payload having characteristics of SQL injection or cross-site scripting. The security management unit drops a malicious request. The security management unit monitors process execution at an endpoint. When an unknown executable file is launched, the security management unit collates its hash value with a threat intelligence database. The security management unit forcibly terminates execution of a process determined to be malware. By this processing, the system defends against cyberattacks from the outside in a multi-layered manner. The system prevents an internal privilege escalation attack. The system maintains confidentiality and integrity of data. The system is applicable to an online banking system of a financial institution and an electronic medical record management system of a medical institution.

The user interface unit operates on a terminal and enables a user to access a server and operate a dashboard, a report, a scenario setting screen, a decision-making plan presentation screen, a feedback input screen, a notification receiving screen, a history reference screen, a report output screen, an alert receiving screen, and the like. For example, a management layer can overlook company-wide market trends and risk scenarios from a terminal, and a field staff member can check demand predictions and inventory optimization plans of their own division, change scenario conditions as necessary, and input feedback on decision-making plans. The user interface unit also implements user authentication, access authority management, a notification function, a report output function, high-speed display by a local cache, temporary storage during offline, secure communication path securing, and the like. Specifically, the user interface unit adopts a reactive programming paradigm. The user interface unit handles a data stream from the server as an observable object. The user interface unit subscribes to this object. The user interface unit automatically executes a callback function every time data is updated. The user interface unit performs difference calculation of a virtual DOM within this callback function. The user interface unit reflects only a changed part to an actual DOM. The user interface unit draws a three-dimensional scatter plot on the dashboard. The user interface unit calls a WebGL API to utilize hardware acceleration by a GPU. The user interface unit smoothly renders tens of thousands of data points. The user interface unit displays a tooltip when the user hovers over a data point. The user interface unit executes validation of an input form on the scenario setting screen. The user interface unit immediately displays an error message when an input value is out of an allowable range. The user interface unit executes a rendering engine that converts an HTML element into a PDF document in the report output function. The user interface unit causes the generated PDF file to be downloaded to a local storage of the user. By this processing, the system presents a large amount of data in a visually easy-to-understand form. The system reduces cognitive load on the user. The system enables interactive data exploration. The system is applicable to an analysis platform for data scientists and a business intelligence tool for a management layer.

The notification receiving unit distributes alerts from the server, updates of decision-making plans, notifications of scenario simulation results, warnings at the time of system failure occurrence, and the like to a user terminal in real time, enabling a user to respond promptly. For example, when a sign of a rapid increase in demand is detected, a terminal of a person in charge of the logistics division is immediately notified to prompt an additional order and a review of a delivery plan. When an increase in investment risk is detected, a warning is transmitted to a person in charge of the investment division to prompt a reconsideration of an investment judgment. Specifically, the notification receiving unit establishes a unidirectional real-time communication channel using server-sent events technology. The notification receiving unit resides as a background process. The notification receiving unit receives JSON format event data pushed from the server. The notification receiving unit analyzes an importance level of the received event data. When the importance is critical, the notification receiving unit calls a native notification API of an operating system. The notification receiving unit displays a pop-up dialog on a screen. The notification receiving unit simultaneously drives a vibration motor of the terminal. When the importance is low, the notification receiving unit quietly adds a message to a notification tray in an application. The notification receiving unit captures an event in which the user clicks a notification. The notification receiving unit changes a routing state of the application to a specific dashboard screen associated with the event. When a network connection is disconnected, the notification receiving unit executes an exponential backoff algorithm to attempt reconnection. The notification receiving unit collectively acquires unread notifications queued on the server side during offline upon reconnection. By this processing, the system transmits occurrence of an important business event to the user without delay. The system prevents opportunity loss. The system maximizes a response speed to risk. The system is applicable to a real-time market alert system for financial traders and an anomaly detection notification system for factory equipment.

The local cache unit temporarily stores recent data and frequently referenced data on a terminal, enabling a user to smoothly use the system even when a network delay or a temporary communication disconnection occurs. For example, even when a field staff member uses a terminal in a place where a network environment is unstable, such as a factory or a warehouse, recent demand predictions and inventory optimization plans can be immediately referenced. Specifically, the local cache unit uses IndexedDB built into a browser as a storage engine. The local cache unit serializes a data object acquired from the server. The local cache unit asynchronously writes this serialized data to a key-value store. The local cache unit assigns an expiration timestamp to each data entry. When receiving a data read request, the local cache unit first searches a local storage. When corresponding data exists and is within an expiration date, the local cache unit bypasses a network request and immediately returns cache data. When data is expired, the local cache unit transmits an asynchronous request to the server in the background. The local cache unit acquires latest data and updates a cache. The local cache unit monitors free capacity of the storage. When a capacity upper limit is reached, the local cache unit executes an LRU algorithm. The local cache unit deletes data in order from oldest unreferenced data. The local cache unit accumulates user input operations in an offline state in a local queue. When detecting that a network connection is recovered, the local cache unit sequentially transmits an operation history in the queue to the server to synchronize states. By this processing, the system provides a stable user experience independent of a network environment. The system reduces unnecessary requests to the server to save a communication bandwidth. The system reduces a load on the server. The system is applicable to a mobile application for maintenance and inspection operating in an underground space or a mountainous area, and a terminal for a cabin crew member used in an aircraft.

Specific examples of prompt sentences to be read by the generative AI when carrying out the present invention include, for example, “Execute demand prediction for the next six months with high accuracy based on shipping data, weather data, and promotion information of the logistics division for the past three years, and if there is a risk of a rapid increase in demand, output its factors and countermeasures together,” “Integrate financial data, industry trends, and reputation data on SNS of emerging companies, analyze growth potential and investment risk for the next two years from multiple angles, and present an index serving as a basis for investment judgment,” “Analyze paper databases, patent databases, news articles, and SNS posts, extract technology trends to be noted next, and output related business fields and market size predictions,” and “Generate an optimal target layer and advertisement budget allocation plan for the next campaign based on consumer behavior data, advertisement effect data, and competitor trend data.” These prompt sentences play a core role in realizing advanced data integration and AI analysis by cooperation of each unit of the system and strongly supporting user decision-making. Specifically, the system incorporates a prompt engineering module. This module dynamically maps an abstract request of a user to a structured prompt template. This module receives, as input data, a numerical array indicating monthly shipping amounts for the past thirty-six months, a floating-point vector indicating an average temperature and precipitation of each month, and a binary array of promotion execution flags. This module converts these numerical data into a text representation of natural language. This module embeds the converted text into a context part of a prompt. This module adds a system prompt instructing a large language model to follow a strict JSON schema for an output format. The large language model receives this prompt as an input. The large language model calculates a dependency relationship between input tokens using a self-attention mechanism. The large language model generates, as an output, a JSON object including a numerical array indicating predicted shipping amounts for the next six months, a score indicating a probability of a rapid increase in demand, and a text string describing countermeasures. The system parses this JSON object. The system transfers the predicted shipping amounts as an input for a subsequent inventory optimization algorithm. The system displays the text of the countermeasures on a dashboard of the user interface unit. The system records an execution history of the prompt and an evaluation score of the user in a database. The system continuously optimizes the prompt template by reinforcement learning using this history data. By this processing, the system maximizes inference capability of the large language model. The system suppresses hallucination and obtains a structured and highly reliable output. The system enables fusion analysis of unstructured data and structured data. The system is applicable to an automatic contract review system of a legal division and an automatic response generation system of customer support.

### Implementation Steps

### Step 1: Data Collection and Acquisition

In this step, a wide variety of data, such as market trend data, consumer behavior data, technology development trend data, supply chain data, investment project data, inventory data, growth index data, financial data, SNS post data, news article data, patent data, paper data, weather data, traffic data, advertisement effect data, customer attribute data, purchase history data, equipment operation data, quality control data, and employee data, are collected and acquired from a plurality of business divisions and related companies such as communication, investment, energy, logistics, marketing, manufacturing, sales, customer support, and research and development, by various means such as API linkage, file transfer, database connection, IoT device linkage, external data provider linkage, and web scraping. For example, an inventory amount and delivery performance are acquired from the logistics division, financial statements and fund procurement history of emerging companies are acquired from the investment division, advertisement placement history and reputation on SNS are acquired from the marketing division, and the number of paper publications and the number of patent applications are acquired from the research and development division. Specifically, in this step, the system activates a distributed data ingestion pipeline. The system generates a dedicated connector process according to characteristics of each data source. The system applies a change data capture technology to a relational database. The system monitors a transaction log of the database. The system detects a record insertion or update event in real time. The system extracts only the detected difference data. The system connects to an IoT device group via an edge computing gateway. The system executes initial filtering of sensor data on the gateway. The system transmits a time-series data stream from which noise has been removed to a message broker on a cloud. The system executes a scraping script that controls a headless browser for an external website. The system extracts text data after rendering dynamically generated HTML content. The system assigns a unique trace ID to all the acquired data. The system generates a metadata catalog including a data source, an acquisition date and time, and a data size. The system registers this catalog in a metadata management repository. The system stores raw data in a landing zone of a data lake in its original format. The system compensates for packet loss and order reversal during data transfer by a retransmission control mechanism of a TCP protocol. By this processing, the system efficiently collects large-scale and diverse data without imposing a load on the entire system. The system maximizes data freshness. The system guarantees a stable data supply to a subsequent machine learning pipeline. The system is applicable to a real-time visualization platform for a global supply chain and a high-frequency trading data collection infrastructure for a financial market.

### Step 2: Data Integration and Preprocessing

In this step, the collected wide variety of data are centrally integrated based on time-series information, attribute information, and ID information, and preprocessing such as missing data complementation, anomaly detection, standardization of units and scales, deduplication, data type conversion, data reliability evaluation, data anonymization and masking, and data encryption is automatically executed. For example, data managed in different units in different divisions are converted into a common unit, daily data and monthly data are integrated, and unstructured data such as SNS post data and news article data are converted into structured data by executing keyword extraction and sentiment analysis using a natural language processing model. Specifically, the data integration unit converts raw data acquired from a plurality of heterogeneous data sources into a high-dimensional tensor format. The data integration unit encodes the time-series information as a timestamp vector. The data integration unit converts the attribute information into a categorical vector by one-hot encoding. The data integration unit maps the ID information to a fixed-length embedding vector using a hash function. The data integration unit combines these vectors to generate an integrated feature tensor. The data integration unit applies a deep learning model using an autoencoder in the missing data complementation. The autoencoder is composed of an input layer, a plurality of intermediate hidden layers, and an output layer. The autoencoder learns a low-dimensional representation of a latent space from an input vector including missing data. The autoencoder reconstructs a missing value through a decoder network. The data integration unit executes an isolation forest algorithm in the anomaly detection. The algorithm calculates an isolation degree of a data point in a high-dimensional space. The data integration unit flags a data point whose isolation degree exceeds a predetermined threshold as an anomaly value. The data integration unit adopts a transformer architecture equipped with a self-attention mechanism as the natural language processing model. The natural language processing model tokenizes input text data. The natural language processing model converts each token into a 512-dimensional word embedding vector. The natural language processing model calculates a contextual dependency between tokens using a multi-head attention mechanism. The natural language processing model generates a continuous value score from minus 1 to plus 1 indicating a sentiment polarity of each text as an output. The natural language processing model outputs a named entity extracted from the text as a structured key-value pair. The data integration unit transfers these structured data to the subsequent generative AI processing unit as input data. This processing method eliminates manual data cleansing by humans. This processing method dramatically improves a processing speed of data integration by using a non-linear transformation in a high-dimensional space. This processing method brings about a technical effect of improving an inference accuracy of a subsequent machine learning model. The system is applicable to various use cases such as market data integration of a financial institution and supply chain data integration of a manufacturing industry. The data integration unit applies an advanced encryption standard algorithm in the data encryption. The data integration unit encrypts data in block units using a 256-bit encryption key. The data integration unit stores the encrypted data in a distributed database. With this configuration, the system reduces a data leakage risk and improves security.

### Step 3: Future Prediction and Scenario Simulation by Generative AI

In this step, the integrated and preprocessed data are input to the generative AI, and future prediction and scenario simulation are executed using a machine learning algorithm, a deep learning model, a natural language processing model, a reinforcement learning model, and the like. For example, a time-series prediction model is used for demand prediction, and future demand is predicted with high accuracy using past demand data, seasonality, promotion information, weather data, economic indicators, and the like as input. A clustering or anomaly detection model is used for market trend analysis to perform market segmentation and detection of sudden changes. A regression analysis or classification model is used for investment risk evaluation to evaluate growth potential and bankruptcy risk of an investment project from multiple angles. A natural language processing model is used for technology trend extraction to extract new technologies and fields of interest from text data such as paper databases, patent databases, news articles, and SNS posts. In the scenario simulation, future predictions are automatically generated under a plurality of hypothetical conditions set by a user, such as “when a new business is started,” “when a specific market grows rapidly,” “when logistics costs soar,” “when regulations are tightened,” “when raw material prices soar,” “when a natural disaster occurs,” and “when a competitor introduces a new product.” Specific examples of prompt sentences to be read by the generative AI include “Based on shipping data, weather data, and promotion information of the logistics division for the past three years, execute a demand prediction for the next six months with high accuracy, and if there is a risk of a sudden increase in demand, output its factors and countermeasures together,” “Integrate financial data of emerging companies, industry trends, and reputation data on SNS, analyze growth potential and investment risk for the next two years from multiple angles, and present indicators that serve as a basis for investment judgment,” “Analyze paper databases, patent databases, news articles, and SNS posts, extract technology trends to pay attention to next, and output related business fields and market size predictions,” and “Generate an optimal target layer and advertisement budget allocation plan for the next campaign based on consumer behavior data, advertisement effect data, and competitor trend data.” Specifically, the generative AI processing unit receives the preprocessed integrated feature tensor as an input. The generative AI processing unit executes a hybrid neural network combining a long short-term memory network and a self-attention mechanism. The neural network receives a one-dimensional array indicating actual demand for the past 365 days, a binary vector indicating the presence or absence of a promotion, and a continuous value vector indicating temperature and precipitation as input data. The neural network combines these input vectors to calculate a 256-dimensional hidden state vector. The neural network updates weight matrices of a forget gate, an input gate, and an output gate in order to learn temporal dependencies. The neural network generates a 30-dimensional numerical vector indicating daily demand prediction values for the next 30 days as output data. The neural network simultaneously outputs vectors of an upper limit value and a lower limit value indicating a 95 percent confidence interval for each prediction value. The generative AI processing unit executes a density-based spatial clustering algorithm in the market trend analysis. The algorithm maps a customer's purchasing behavior vector to a high-dimensional space. The algorithm calculates a local density of data points and extracts a high-density region as a cluster. The generative AI processing unit executes a gradient boosting decision tree model in the investment risk evaluation. The model receives a financial indicator vector of a company as an input. The model connects a plurality of weak learners in series and updates weights so as to minimize a prediction error. The model generates a continuous value score from 0 to 1 indicating a bankruptcy probability within one year as an output. The generative AI processing unit executes a probabilistic simulation engine based on a Monte Carlo method in the scenario simulation. The simulation engine receives the hypothetical conditions set by the user as parameters of a probability distribution. The simulation engine executes tens of thousands of trials in parallel using a random number generator. The simulation engine aggregates results of each trial and outputs a probability density function of future sales. This processing method is fundamentally different from conventional prediction methods that rely on human intuition. This processing method mathematically models complex non-linear relationships in a high-dimensional data space. With this configuration, the system exhibits a technical effect of significantly reducing prediction errors and optimizing utilization efficiency of computational resources. The system is applied to use cases requiring advanced prediction, such as inventory optimization in the retail industry and stress testing in financial institutions. The generative AI processing unit extracts technology trends using a natural language processing model. The natural language processing model receives text data of patent documents as an input. The natural language processing model calculates a topic distribution vector using a latent Dirichlet allocation method. The natural language processing model outputs a group of keywords whose appearance frequency is rapidly increasing as a new technology trend. The generative AI processing unit transmits these output results to the subsequent decision-making support unit.

### Step 4: Automatic Generation and Optimization of Decision-Making Plan

In this step, decision-making plans for resource allocation, investment judgment, inventory management, supply chain optimization, risk evaluation, project prioritization, capital investment planning, personnel allocation planning, advertisement budget allocation, price strategy formulation, customer targeting, campaign optimization, quality improvement proposal, equipment maintenance planning, and the like are automatically generated based on a future prediction result and a scenario simulation result by the generative AI processing unit. For example, in the logistics division, an optimal additional order amount, delivery plan, inventory transfer plan, and emergency countermeasure are automatically calculated in consideration of predicted demand, current inventory amount, warehouse capacity, delivery cost, lead time, weather risk, traffic conditions, and the like. In the investment division, an investment amount, investment timing, investment recovery scenario, risk diversification plan, and withdrawal criteria are automatically proposed for fields and companies expected to grow. In the energy division, an optimal energy allocation, procurement plan, supply and demand adjustment plan, and renewable energy introduction plan are automatically generated based on power generation amount prediction, consumption amount prediction, fuel price, equipment operation rate, supply and demand balance, and regulatory trends. In the marketing division, an optimal promotion strategy, advertisement budget allocation, targeting plan, product pricing plan, and campaign schedule plan are automatically proposed based on consumer behavior prediction, advertisement effect analysis, competitor trends, seasonality, and promotion history. Specifically, the decision-making support unit receives a prediction vector and probability distribution data output from the generative AI processing unit. The decision-making support unit executes a mathematical optimization solver. The mathematical optimization solver implements a mixed integer linear programming algorithm. The mathematical optimization solver receives a predicted demand amount vector of each base, a current inventory amount vector, and a transportation cost matrix between bases as input data. The mathematical optimization solver sets minimization of total logistics cost as an objective function. The mathematical optimization solver sets a maximum storage capacity of each warehouse and a maximum load capacity of a delivery vehicle as constraint conditions. The mathematical optimization solver searches for an optimal solution using a branch and bound method. The mathematical optimization solver generates an optimization matrix indicating an optimal delivery amount from each base to each customer as output data. The mathematical optimization solver outputs structured data indicating a product ID requiring an additional order and an order amount. The decision-making support unit executes a reinforcement learning agent in processing for the investment division. The reinforcement learning agent interacts with an environment model based on a Markov decision process. The reinforcement learning agent receives a current portfolio configuration and a market volatility index as a state vector. The reinforcement learning agent selects a trading ratio of each asset as an action space. The reinforcement learning agent sets maximization of a Sharpe ratio as a reward function. The reinforcement learning agent updates weights of a policy network using a proximal policy optimization algorithm. The reinforcement learning agent generates a continuous value vector indicating an optimal asset allocation ratio as an output. The decision-making support unit executes a dynamic programming algorithm in processing for the energy division. The algorithm receives a power demand prediction vector and a renewable energy power generation amount prediction vector for each time zone as an input. The algorithm optimizes a charge and discharge schedule of a storage battery. The algorithm generates a time-series array indicating an optimal charge and discharge amount for each time zone as an output. This processing method replaces a decision-making process based on human rules of thumb with a strict mathematical optimization process. This processing method calculates a Pareto optimal solution at high speed in a multi-objective optimization problem. With this configuration, the system brings about a technical effect of eliminating waste in resource allocation and dramatically reducing operation costs. The system is applicable to use cases requiring optimization under complex constraint conditions, such as production planning in the manufacturing industry and bandwidth allocation in a communication network. The decision-making support unit formats the generated decision-making plan as structured data in a JSON format. The decision-making support unit transmits the formatted data to the user interface unit.

### Step 5: Presentation of Decision-Making Plan to User and Acquisition of Feedback

In this step, the decision-making plan automatically generated by the decision-making support unit is presented to a terminal through the user interface unit, and a user operates a dashboard, a report, a scenario setting screen, a decision-making plan presentation screen, a feedback input screen, a notification receiving screen, a history reference screen, a report output screen, an alert receiving screen, and the like to perform adoption, modification, or rejection of the decision-making plan, change of scenario conditions, input of feedback, and the like. For example, a management layer can overlook company-wide market trends and risk scenarios, and a field staff member can check demand predictions and inventory optimization plans of his/her own division, change scenario conditions as necessary, and input feedback on the decision-making plan. Specifically, the user interface unit analyzes the structured data received from the decision-making support unit. The user interface unit generates a dynamic web page based on an analysis result. The user interface unit executes a graphics rendering engine to visualize prediction data and optimization results. The rendering engine draws time-series prediction data as a vector image of a line graph. The rendering engine superimposes and displays an optimized delivery route as polygon data on a geographic information system. The user interface unit activates an event listener that monitors an input operation from the user. The event listener detects a change event when the user operates a slider on a screen to change a scenario condition. The user interface unit packages the changed parameter as a new input vector. The user interface unit transmits the packaged data to a server using an asynchronous communication protocol. The user interface unit provides a text input field for receiving feedback from the user. The user interface unit transfers the input text data to a natural language processing module. The natural language processing module extracts a feature vector indicating a user's intention from the text data. The user interface unit acquires a binary flag indicating adoption or rejection of the decision-making plan. The user interface unit stores the acquired binary flag in a log management unit as training data. This processing method is not limited to mere display of information, but constructs an interactive feedback loop between a human and a computer. This processing method utilizes an asynchronous rendering technology on a client side in order to minimize a user's operation delay. With this configuration, the system exhibits a technical effect of accurately reflecting the user's intention in parameters inside the system. The system is applied to use cases corresponding to diverse user layers, such as a strategy dashboard for a management layer and a mobile application for a field worker. The user interface unit executes a color coding process according to an importance level on the alert receiving screen. The user interface unit triggers a screen blinking process and an audio output process for an alert whose importance level exceeds a threshold. The user interface unit records a user's operation history in a local storage together with a timestamp.

### Step 6: Reflection of Feedback to Generative AI and Self-Learning

In this step, feedback from a user, performance data, and external environment change data are automatically fed back to the generative AI processing unit, and the generative AI automatically optimizes parameters and a structure of a model to continuously improve prediction accuracy and quality of a decision-making plan. For example, when a deviation between actual demand and a prediction value is large, a cause analysis is automatically executed, and relearning of the model and addition/deletion of feature amounts are automatically performed. Specific examples of prompt sentences to be read by the generative AI include “When a deviation between a demand prediction and a performance value for the latest three months is large, analyze its factors and automatically execute relearning of a model and review of feature amounts,” and “Optimize parameters of a decision-making plan generation algorithm based on feedback content from a user, and reflect them at the time of the next proposal.” Specifically, the generative AI processing unit receives the feedback data and the performance data transmitted from the user interface unit. The generative AI processing unit activates an online learning module. The online learning module calculates an error between the prediction value and the performance value. The online learning module uses a mean squared error or a cross-entropy loss as an error function. The online learning module propagates the calculated error gradient to each layer of a neural network using a backpropagation method. The online learning module minutely updates a weight matrix and a bias vector of the network using a stochastic gradient descent method or an adaptive moment estimation algorithm. The generative AI processing unit executes a feature engineering module. The feature engineering module extracts a data point having a large prediction error. The feature engineering module executes a principal component analysis on the extracted data point to specify a main variance direction of the error. The feature engineering module automatically generates a new feature vector based on the specified variance direction. The generative AI processing unit adds the generated feature vector to an input data set. The generative AI processing unit executes a hyperparameter optimization module. The hyperparameter optimization module dynamically adjusts a learning rate, a batch size, and the number of nodes in a hidden layer using a Bayesian optimization algorithm. The generative AI processing unit inputs text feedback from the user to a natural language processing model. The natural language processing model calculates a reward score from the feedback content. The generative AI processing unit updates a policy gradient of a reinforcement learning model using the calculated reward score. This processing method eliminates static model operation and realizes a dynamic self-learning mechanism that autonomously adapts to environmental changes. This processing method continuously improves prediction accuracy without human intervention by automating a relearning process of the model. With this configuration, the system brings about a technical effect of preventing deterioration of the model over time and always maintaining optimal inference performance. The system is applicable to use cases with high environmental non-stationarity, such as inventory management in the apparel industry with severe demand fluctuations and algorithmic trading in financial markets. The generative AI processing unit stores the updated weight parameters of the model in a version control system. The generative AI processing unit automatically executes an AB test in the background to compare performance of old and new models.

### Specific Use Case

For example, assume a case where company-wide demand prediction and resource allocation optimization are implemented using the system of the present invention in a corporate group having a plurality of business divisions such as a logistics division, an investment division, a marketing division, an energy division, a manufacturing division, and a research and development division. First, an inventory amount, shipping performance, delivery delay history, warehouse operation rate, weather data, traffic data, and the like for the past several years are collected from the logistics division by the data integration unit. Financial statements, fund procurement history, industry trends, manager attributes, past investment performance, reputation data on SNS, and the like of emerging companies are collected from the investment division. Advertisement placement history, campaign effects, consumer questionnaire results, SNS post data, competitor trend data, purchase history data, and the like are collected from the marketing division. Power generation amount, consumption amount, equipment operation rate, fuel price, supply and demand balance, regulatory trends, and the like are collected from the energy division. Production volume, equipment operation rate, quality defect rate, raw material inventory, delivery date constraints, equipment maintenance history, and the like are collected from the manufacturing division. The number of paper publications, the number of patent applications, technology evaluation scores, technology blog articles, external news articles, and the like are collected from the research and development division. Specifically, the system deploys a plurality of data collection agents operating on a distributed computing environment. The data collection agent issues an asynchronous query to a local database of each business division. The data collection agent extracts millions of rows of transaction data including a product ID, a timestamp, and a shipping quantity from a system of the logistics division. The data collection agent packetizes the extracted data and transfers it to a central server via a secure communication channel. The data collection agent acquires a multidimensional numerical matrix indicating financial indicators of a company from a system of the investment division. The data collection agent acquires a time-series log file including clickstream data of a customer on a website from a system of the marketing division. The data collection agent acquires a time-series array of power consumption measured by a smart meter at one-minute intervals from a system of the energy division. The data collection agent acquires a binary data stream of an equipment operation status output by a programmable logic controller from a system of the manufacturing division. The data collection agent acquires a large-capacity document corpus including full-text data of patent documents from a system of the research and development division. The system temporarily caches these heterogeneous format data on an in-memory data grid. The system applies a parallel processing framework to the cached data to execute parsing and validation of the data at high speed. This processing method physically and logically integrates siloed inter-departmental data. This processing method utilizes a data compression algorithm on an edge side in order to minimize consumption of network bandwidth. With this configuration, the system exhibits a technical effect of collecting a huge amount of company-wide data in real time and supplying it to a subsequent machine learning pipeline without delay. The system is applied to use cases having a large-scale and complex data environment, such as global supply chain management of a multinational company and integrated risk management of a conglomerate company. The system includes a fault-tolerant mechanism that automatically executes a retry process when a failure occurs in a data collection process. The system calculates a hash value of the collected data to verify integrity of the data.

The data integration unit centrally integrates these wide variety of data based on time-series information, attribute information, and ID information, and automatically executes preprocessing such as missing data complementation, anomaly detection, standardization of units and scales, deduplication, data type conversion, data reliability evaluation, data anonymization and masking, and data encryption. For example, when inventory data of the logistics division is managed on a daily basis and sales data of the sales division is managed on a monthly basis, daily data is aggregated into monthly data to unify units. Unstructured data such as SNS post data and news article data are converted into structured data by executing keyword extraction and sentiment analysis using a natural language processing model. Specifically, the data integration unit maps the collected raw data to a multidimensional integrated feature space. The data integration unit executes a spline interpolation algorithm in order to synchronize time-series data having different time resolutions. The data integration unit applies a moving average filter and a downsampling process when aggregating daily data into monthly data. The data integration unit executes matrix multiplication using a transformation matrix in unifying units, and converts all physical quantities into a standardized vector based on the International System of Units. The data integration unit executes a machine learning algorithm based on a K-nearest neighbor method for missing data complementation. The algorithm calculates a Euclidean distance between data points in a feature space, and estimates a missing element using a weighted average of neighboring data. The data integration unit calculates a Mahalanobis distance for anomaly detection. The data integration unit removes a data point whose Mahalanobis distance is included in a rejection region of a chi-square distribution as an outlier. The data integration unit activates a pre-trained self-attention neural network in processing unstructured data. The neural network divides input text data into subword tokens. The neural network converts each token into a 768-dimensional embedding vector. The neural network generates a category label of a named entity included in the text and a continuous value score indicating a sentiment polarity as an output. The data integration unit converts these outputs into a structured record conforming to a table schema of a relational database. The data integration unit applies a k-anonymity algorithm in data anonymization to generalize or suppress an attribute vector capable of identifying an individual. This processing method completely automates a manual data shaping process by humans. This processing method resolves semantic inconsistencies of heterogeneous data by mathematical transformation. With this configuration, the system brings about a technical effect of dramatically improving quality of data input to a subsequent AI model and reducing inference errors. The system is applicable to use cases where data formats are extremely diverse, such as integration of electronic medical record data in a medical institution and integration of multimodal sensor data in a smart city. The data integration unit stores the preprocessed data in a storage in a column-oriented database format capable of high-speed reading.

The generative AI processing unit executes future prediction and scenario simulation using a machine learning algorithm, a deep learning model, a natural language processing model, and the like with the integrated and preprocessed data as input. For example, for demand prediction in the logistics division, a time-series prediction model is used to predict future demand with high accuracy using past shipping data, seasonality, promotion information, weather data, economic indicators, and the like as input. In the investment division, financial data of emerging companies, industry trends, reputation data on SNS, managers' backgrounds, past investment performance data, and the like are integrated, and the generative AI evaluates growth potential and risk from multiple angles. In the marketing division, an optimal target layer and an advertisement budget allocation plan for the next campaign are generated based on consumer behavior data, advertisement effect data, and competitor trend data. In the energy division, an optimal energy allocation, a procurement plan, a supply and demand adjustment plan, and a renewable energy introduction plan are automatically generated based on power generation amount prediction and consumption amount prediction, fuel prices, equipment operation rates, supply and demand balance, and regulatory trends. In the manufacturing division, a production plan, a raw material ordering plan, a quality improvement plan, and an equipment maintenance plan are automatically generated based on demand prediction, production capacity, equipment operation rates, raw material inventory, quality defect rates, and delivery time constraints. In the research and development division, text data such as paper databases, patent databases, news articles, SNS posts, and technology blogs are analyzed by a natural language processing model to extract technology trends and research themes to be noted next. Specifically, the generative AI processing unit receives a preprocessed multidimensional tensor as input. The generative AI processing unit executes a hybrid architecture combining a convolutional neural network and a long short-term memory network in the demand prediction of the logistics division. The hybrid architecture receives a one-dimensional array indicating the shipping volume for the past 100 days and a multidimensional vector indicating weather data as input data. The hybrid architecture generates a 14-dimensional numerical vector indicating daily demand prediction values for the next 14 days as output. The generative AI processing unit executes a graph neural network in the evaluation of the investment division. The graph neural network receives an adjacency matrix expressing transaction relationships and investment relationships between companies by nodes and edges as input. The graph neural network aggregates feature vectors of nodes with neighboring nodes, and outputs a continuous value from 0 to 1 indicating a growth score of each company. The generative AI processing unit executes a recommendation algorithm integrating collaborative filtering and deep learning in the processing of the marketing division. The recommendation algorithm receives a user's purchase history vector and an item's feature vector as input. The recommendation algorithm calculates an inner product in a latent feature space of the user and the item, and outputs a score matrix indicating a reaction probability of the campaign for each user. The generative AI processing unit executes a reinforcement learning agent based on a Markov decision process in the processing of the energy division. The reinforcement learning agent receives a current power generation amount and a power demand amount as a state vector. The reinforcement learning agent selects an output adjustment amount of each power generation facility as an action. The reinforcement learning agent sets minimization of operation cost as a reward function, and outputs a vector indicating an optimal output adjustment amount. The generative AI processing unit executes a constrained optimization algorithm in the processing of the manufacturing division. The algorithm formulates production capacity and delivery time constraints as inequality constraints, and outputs an optimal production schedule matrix that minimizes total production time. The generative AI processing unit executes a topic modeling algorithm in the processing of the research and development division. The algorithm receives a word appearance frequency matrix of patent documents as input, and outputs a probability vector indicating a distribution of latent technology topics. The processing method dynamically allocates an optimal mathematical model to a specific problem of each division. The processing method executes nonlinear operations in a high-dimensional space at high speed on a parallel processing processor. With this configuration, the system exhibits a technical effect of improving the accuracy of company-wide decision-making and maximizing the utilization efficiency of computational resources. The system is applied to use cases requiring complex system control, such as autonomous control of a smart factory and power grid optimization of a smart grid. The generative AI processing unit integrates inference results of each model, and automatically generates a sensitivity analysis report indicating a degree of influence on company-wide KPIs.

The decision-making support unit automatically generates decision-making plans for resource allocation, investment judgment, inventory management, supply chain optimization, risk evaluation, project prioritization, equipment investment plan, personnel allocation plan, advertisement budget allocation, price strategy formulation, customer targeting, campaign optimization, quality improvement proposal, equipment maintenance plan, and the like based on a future prediction result and a scenario simulation result by the generative AI processing unit, and presents the decision-making plans to the terminal through the user interface unit. For example, in the logistics division, an optimal additional order amount, a delivery plan, an inventory movement plan, and an emergency countermeasure are automatically calculated in consideration of predicted demand and current inventory amount, warehouse capacity, delivery cost, lead time, weather risk, traffic conditions, and the like. In the investment division, an investment amount, an investment timing, an investment recovery scenario, a risk diversification plan, and a withdrawal criterion are automatically proposed for fields and companies expected to grow. In the marketing division, an optimal promotion strategy, an advertisement budget allocation, a targeting plan, a product price setting plan, and a campaign schedule plan are automatically proposed based on consumer behavior prediction, advertisement effect analysis, competitor trends, seasonality, and promotion history. Specifically, the decision-making support unit receives the prediction vector and the probability distribution matrix output from the generative AI processing unit. The decision-making support unit executes a multi-objective optimization algorithm. The multi-objective optimization algorithm implements a genetic algorithm. The genetic algorithm receives a predicted KPI vector of each division, a scalar value indicating a budget constraint, and a vector indicating an available amount of resources as input data. The genetic algorithm generates a population of initial decision-making plans as random bit strings. The genetic algorithm calculates fitness of each individual using an evaluation function. The evaluation function quantifies a trade-off between profit maximization and risk minimization. The genetic algorithm iteratively applies selection, crossover, and mutation operators to generate a next-generation population. The genetic algorithm outputs a set of optimal solutions constituting a Pareto front after reaching a predetermined number of generations. The decision-making support unit extracts an integer vector indicating an optimal replenishment amount to each warehouse and graph structure data indicating routing of delivery vehicles from the output optimal solutions in the processing for the logistics division. The decision-making support unit extracts a floating-point vector indicating a fund allocation ratio to each portfolio and threshold data indicating a stop-loss line from the output optimal solutions in the processing for the investment division. The decision-making support unit extracts a numerical matrix indicating a budget allocation amount to each advertisement channel and array data indicating an ID list of target customers from the output optimal solutions in the processing for the marketing division. The decision-making support unit packages these extracted data as a structured object in JSON format. The decision-making support unit transmits the packaged object to the user interface unit. The processing method searches for a mathematically proven optimal solution from an enormous number of combinations exceeding human cognitive limits. The processing method solves a nonlinear and non-convex optimization problem within a realistic calculation time by using a heuristic search method. With this configuration, the system brings about a technical effect of dramatically improving resource allocation efficiency of the entire company and minimizing opportunity loss. The system is applicable to use cases having dynamic and complex constraints, such as flight schedule optimization of an airline and operation resource allocation of a large-scale event. The decision-making support unit assigns an explainability score indicating a contribution degree of a feature amount serving as a basis thereof to the generated decision-making plan.

A user operates a dashboard, a report, a scenario setting screen, a decision-making plan presentation screen, a feedback input screen, a notification receiving screen, a history reference screen, a report output screen, an alert receiving screen, and the like from the terminal, and performs adoption/modification/rejection of a decision-making plan, change of scenario conditions, input of feedback, and the like. For example, a management layer can overlook company-wide market trends and risk scenarios, and a field staff member can confirm demand prediction and an inventory optimization plan of his/her own division, change scenario conditions as necessary, and input feedback to the decision-making plan. Specifically, the user interface unit parses the structured object received from the decision-making support unit. The user interface unit dynamically renders a single-page application operating on a web browser based on the parsed data. The user interface unit executes a data visualization library on the dashboard screen, and draws multidimensional data as vector graphics of a heat map or a scatter plot. The user interface unit activates an event handler that detects a parameter change input by the user on the scenario setting screen. When the user operates a slider to increase a demand increase rate by 10 percent, the event handler captures the changed value as floating-point data. The user interface unit asynchronously transmits the captured data to the server as a new input vector. The user interface unit provides “adopt”, “modify”, and “reject” buttons for each proposal on the decision-making plan presentation screen. When the user clicks the “adopt” button, the user interface unit records the operation event as a binary log together with a time stamp and a user ID. The user interface unit acquires a natural language text input by the user on the feedback input screen. The user interface unit transmits the acquired text data to the server as string data of UTF-8 encoding. The processing method decentralizes rendering processing by utilizing computational resources of the client terminal. The processing method minimizes processing delay accompanying screen redrawing by using virtual DOM technology. With this configuration, the system provides an intuitive and high-speed operation environment to the user, and exhibits a technical effect of improving responsiveness of a human-machine interface. The system is applied to use cases requiring instantaneous operation, such as a real-time monitoring system in a control room of a factory and a high-speed trading terminal for financial traders. The user interface unit executes access control logic that dynamically filters data items to be displayed in accordance with an authority level of the user. When a network connection is disconnected, the user interface unit reads data from the local cache unit and continues display in an offline mode.

Specific examples of prompt sentences to be read by the generative AI include, for example, “Execute demand prediction for the next 6 months with high accuracy based on shipping data, weather data, and promotion information of the logistics division for the past 3 years, and if there is a risk of a rapid increase in demand, output its factors and countermeasures together”, “Integrate financial data of emerging companies, industry trends, and reputation data on SNS, analyze growth potential and investment risk for the next 2 years from multiple angles, and present indicators serving as a basis for investment judgment”, “Analyze paper databases, patent databases, news articles, and SNS posts, extract technology trends to be noted next, and output related business fields and market size prediction”, and “Generate an optimal target layer and an advertisement budget allocation plan for the next campaign based on consumer behavior data, advertisement effect data, and competitor trend data”. Furthermore, prompts for self-learning and feedback reflection are also utilized, such as “If a divergence between demand prediction and a performance value for the latest 3 months is large, analyze its factors and automatically execute re-learning of a model and review of feature amounts” and “Optimize parameters of a decision-making plan generation algorithm based on feedback contents from a user, and reflect them at the time of the next proposal”. Specifically, the generative AI processing unit processes these prompt sentences as input queries to the natural language processing model. The generative AI processing unit inputs the prompt sentences to a tokenizer, and converts them into an integer index array. The generative AI processing unit inputs the index array to an embedding layer, and generates a high-dimensional continuous value vector representation. The generative AI processing unit analyzes instruction contents included in the prompt sentences, and classifies a type of task to be executed. When a demand prediction task is designated, the generative AI processing unit dynamically constructs an inference pipeline of a time-series prediction model. The generative AI processing unit combines a time-series tensor indicating shipping volume for the past 3 years, a multidimensional matrix indicating weather data, and a binary vector indicating presence or absence of promotion as input data. The generative AI processing unit generates a 6-dimensional numerical vector indicating monthly demand prediction values for the next 6 months and a continuous value score from 0 to 1 indicating a rapid demand increase probability as output. When an investment analysis task is designated, the generative AI processing unit activates a multimodal neural network that integrally processes financial data and text data. The neural network generates a floating-point value indicating a growth score of a company and text data extracting risk factors as output. When a technology trend extraction task is designated, the generative AI processing unit executes latent semantic analysis on a corpus of patent documents. The generative AI processing unit generates a list of rapidly growing technology keywords and numerical data indicating a prediction value of a related market size as output. When a self-learning task is designated, the generative AI processing unit calculates a gradient of a prediction error, and automatically updates weight parameters of a model using an error backpropagation method. The processing method converts an abstract instruction in natural language into a specific operation graph executable by a computer. The processing method causes a single foundation model to flexibly execute various tasks by utilizing prompt engineering technology. With this configuration, the system brings about a technical effect of reducing cost for developing a dedicated model for each task and dramatically improving versatility and expandability of the system. The system is applicable to use cases in which atypical analysis tasks frequently occur, such as strategy planning support in a corporate planning division and new theme search in a research and development division. The generative AI processing unit formats the generated output result as structured data in JSON format, and transfers it to a subsequent module.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. A logistics center optimization system of the present invention is composed of a server and a terminal, wherein a data integration unit, a generative AI processing unit, a decision-making support unit, a log management unit, and a security management unit are implemented in the server, and a user interface unit, a notification receiving unit, and a local cache unit are implemented in the terminal. The server can be constructed in various forms such as a cloud infrastructure, an on-premises server, a virtual server, and a distributed server, and the terminal is composed of various devices such as a personal computer, a tablet, a smartphone, a wearable device, and a dedicated business terminal. Specifically, the logistics center optimization system adopts a distributed computing environment based on a microservices architecture. The server functions as a cluster system composed of a plurality of computing nodes. Each computing node is equipped with a multi-core processor, a large-capacity random access memory, and a graphics processing unit for parallel computing. The server deploys each module of the data integration unit, the generative AI processing unit, the decision-making support unit, the log management unit, and the security management unit as an independent container using a container orchestration tool. The server receives a request from the outside via a load balancer, and dynamically distributes traffic to each container. The terminal is equipped with a web browser engine or a dedicated native application for executing the user interface unit. The terminal executes a background service that processes a push notification protocol as the notification receiving unit. The terminal utilizes an embedded database system constructed on a flash memory as the local cache unit. The system establishes an encrypted communication channel using a secure socket layer protocol in communication between the server and the terminal. The system executes data exchange between modules at high speed using a RESTful application programming interface or a gRPC protocol. The processing method eliminates a monolithic system structure and enhances independence of each functional module. The processing method includes an auto-scaling function that automatically scales out a specific container in accordance with a load situation. With this configuration, the system exhibits a technical effect of improving throughput in large-scale logistics data processing and strengthening fault tolerance of the entire system. The system is applied to use cases requiring high availability and scalability, such as integrated management of a large-scale logistics network deploying dozens of bases nationwide and optimization of a global supply chain in cross-border e-commerce. The security management unit executes a token-based authentication and authorization process for all access requests, and blocks unauthorized access.

The data integration unit operates on the server and collects a wide variety of data, such as shipping performance data inside and outside a logistics center, inventory data, receipt and shipment history data, delivery destination information, weather data, traffic data, worker operation data, equipment operation history data, external event data, shift tables, maintenance records, and IoT sensor data, by various means such as API linkage, file transfer (CSV, Excel, JSON, XML, etc.), database connection (SQL, NoSQL, etc.), IoT device linkage, external data provider linkage, and Web scraping. For example, the shipping performance data includes daily/hourly shipping volume, shipping volume by delivery destination, shipping volume by product, emergency shipping history, return history, delivery delay history, loading rate for each delivery vehicle, shipping volume for each delivery route, shipping patterns in busy/slack seasons, and the like. The inventory data includes inventory amount by product, receipt/shipment history, best-before/expiration date management data, lot management data, inventory taking history, inventory turnover rate, inventory distribution by storage area, inventory retention days, shortage occurrence history, excess inventory occurrence history, and the like. The weather data includes rainfall, temperature, typhoon information, snowfall information, weather warnings, humidity, atmospheric pressure, wind speed, weather forecast data, past disaster occurrence history, and the like. The traffic data includes congestion indices of major roads, accident occurrence information, traffic regulation information, road construction information, required time for each delivery route, road closure information by road, traffic volume prediction data, past traffic obstacle history, and the like. The worker operation data includes shift tables, attendance records, work history for each worker, skill information, vacation schedules, workload history, productivity indices by worker, error occurrence history by worker, health condition data of workers, qualification/license information of workers, and the like. The equipment operation history data includes operation history of forklifts and automatic guided vehicles, maintenance records, failure history, operation rates, operation time, consumable part replacement history, energy consumption by equipment, operation cost by equipment, operation schedules of equipment, anomaly detection history of equipment, and the like. The external event data includes large-scale sales, holidays, disasters, regulatory changes, event information of neighboring facilities, social events (sports tournaments, elections, festivals, etc.), campaign information of competitors, logistics regulation information of administration, and the like. The IoT sensor data includes temperature/humidity sensors, vibration sensors, position information sensors, entry/exit management sensors, energy consumption sensors, baggage weight sensors, door opening/closing sensors, illuminance sensors, noise sensors, air quality sensors, and the like. Specifically, the data integration unit executes a multi-threaded data collection daemon implementing asynchronous IO processing. The data collection daemon issues an SQL query to a warehouse management system in the logistics center, and extracts millions of transaction records including product IDs, time stamps, and quantities. The data collection daemon transmits an HTTP request to an API endpoint of an external weather information provider, and acquires a JSON payload of floating-point data indicating temperature, precipitation, and wind speed. The data collection daemon receives a stream of sensor data transmitted every second via an MQTT protocol from thousands of IoT sensors arranged in the logistics center. The data collection daemon extracts a continuous value indicating temperature, a numerical value indicating amplitude of vibration, and latitude and longitude coordinates indicating position information from the received sensor data. The data collection daemon acquires a time-series array of heart rate and acceleration data transmitted from a smartwatch of a worker. The data collection daemon acquires a binary log file including a remaining battery level, a travel distance, and an error code from a control unit of an automatic guided vehicle. The data integration unit temporarily buffers these data of heterogeneous formats in an in-memory message queue system. The data integration unit asynchronously reads data from the message queue, and executes parsing processing in accordance with a common data schema. The processing method minimizes delay in data collection by combining a polling method and an event-driven method. The processing method utilizes data compression and filtering processing on an edge device side in order to efficiently use network bandwidth. With this configuration, the system brings about a technical effect of capturing an enormous amount of data generated inside and outside the logistics center in real time and stably supplying it to a subsequent analysis pipeline. The system is applicable to use cases requiring strict data tracking, such as temperature management of a cold chain handling fresh food and safety monitoring of a special warehouse handling dangerous goods. The data integration unit calculates a checksum of the collected data, and executes data integrity verification logic that detects data loss or falsification during transmission.

The data integration unit centrally integrates these data based on time-series information (year, month, day, hour, minute, second), attribute information (product, area, worker ID, equipment ID, delivery destination ID, vehicle ID, etc.), and ID information (transaction ID, product ID, work ID, event ID, etc.). As preprocessing of data, missing data complementation (mean complementation, regression complementation, time-series complementation, neighborhood complementation, etc.), anomaly detection (statistical method, machine learning-based outlier detection, rule-based detection, etc.), standardization of units and scales (z-score normalization, min-max scaling, unit conversion, etc.), deduplication, data type conversion (date type, numerical type, category type, logical type, etc.), data reliability evaluation (reliability of data source, acquisition date and time, data freshness, data acquisition frequency, data consistency, etc.), data anonymization/masking (personal information protection compliance, privacy protection compliance), data encryption (encryption during storage/transfer), data compression/division/integration, data version management, and the like are automatically executed. For example, data managed in different units (number of pieces, cases, pallets, weight, volume, etc.) in different systems are converted into a common unit, daily data and hourly data are integrated, and a real-time stream of IoT sensor data is stored in a time-series database and integrated with other data. Unstructured data (free description memos of workers, equipment failure reports, external news articles, SNS posts, inquiry records from customers, etc.) are converted into structured data by executing keyword extraction, sentiment analysis, topic classification, summary generation, and the like using a natural language processing model. Image data and video data (surveillance camera video in a warehouse, images of baggage, etc.) are integrated as event data by performing object detection and anomaly detection using an image recognition model. Specifically, the data integration unit converts the collected raw data into a multidimensional integrated feature tensor. The data integration unit encodes time-series information as a continuous value vector of UNIX epoch time. The data integration unit converts attribute information and ID information into a dense vector representation using one-hot encoding or an embedding layer. The data integration unit executes a deep learning model using an autoencoder in missing data complementation. The autoencoder learns a low-dimensional representation of a latent space from an input vector including missing data, and reconstructs missing elements through a decoder network. The data integration unit executes an isolation forest algorithm in anomaly detection. The algorithm calculates an isolation degree of a data point in a high-dimensional space, and flags a data point whose isolation degree exceeds a predetermined threshold as an anomaly. The data integration unit executes matrix multiplication using a conversion matrix in standardization of units, and converts all physical quantities into a standardized vector based on the International System of Units. The data integration unit activates a natural language processing model based on a transformer architecture equipped with a self-attention mechanism in processing of unstructured data. The natural language processing model tokenizes input text data, and converts each token into a 768-dimensional embedding vector. The natural language processing model generates a category label of a named entity included in the text and a continuous value score indicating sentiment polarity as output. The data integration unit executes an object detection model based on a convolutional neural network in processing of image data. The object detection model extracts a feature map from an input image tensor, and outputs bounding box coordinates and class probabilities of baggage and workers in the image. The data integration unit converts these outputs into a structured record conforming to a table schema of a relational database. The processing method eliminates manual data cleansing by humans, and completely automates a data processing pipeline. The processing method resolves semantic inconsistency of heterogeneous data by mathematical conversion. With this configuration, the system exhibits a technical effect of dramatically improving quality of data input to a subsequent AI model and reducing inference errors. The system is applied to use cases in which data formats are extremely diverse, such as operation of an automated huge fulfillment center and a smart factory utilizing multimodal sensor data. The data integration unit stores the preprocessed data in a storage in a column-oriented database format capable of high-speed reading.

The generative AI processing unit operates on the server and utilizes generative AI as an essential element with the integrated and preprocessed data as input. The generative AI is configured by combining a machine learning algorithm (random forest, gradient boosting, support vector machine, decision tree, linear regression, logistic regression, etc.), a deep learning model (LSTM, GRU, Transformer, CNN, GAN, etc.), a natural language processing model (large language model, BERT, GPT, Doc2Vec, Word2Vec, etc.), a reinforcement learning model (Q-learning, SARSA, Deep Q Network, etc.), an anomaly detection model (Isolation Forest, AutoEncoder, etc.), a clustering model (K-means, hierarchical clustering, DBSCAN, etc.), a regression model, a classification model, and an optimization algorithm (linear programming, integer programming, metaheuristics, etc.). For example, for demand prediction, a time-series prediction model such as LSTM or Transformer is used to predict future demand with high accuracy using past shipping data, seasonality, promotion information, weather data, traffic data, economic indicators, external event information, competitor trends, and the like as input. For inventory optimization, an optimal inventory amount that minimizes excess inventory and shortage risk is automatically calculated in consideration of a demand prediction result, receipt and shipment history, inventory turnover rate, best-before date information, storage space constraints, ordering lead time, ordering cost, inventory storage cost, shortage penalty cost, and the like. For delivery plan optimization, an optimal delivery route and delivery schedule are automatically generated in consideration of shipping volume prediction, delivery destination information, traffic conditions, number of vehicles, driver shifts, road regulation information, delivery cost, delivery time constraints, delivery priority, risk information for each delivery route, and the like. For worker allocation optimization, the generative AI utilizes clustering and an optimization algorithm based on predicted shipping volume and inventory fluctuation, workers' skills and past work history, shift requests, vacation schedules, workload history, workers' health conditions, qualification/license information, productivity indices by worker, and the like, and automatically generates an optimal worker allocation plan for each time zone and each area. For equipment operation prediction, an operation rate and failure risk of equipment are predicted based on past equipment operation history and maintenance records, predicted shipping volume and workload, equipment operation schedules, life prediction of consumable parts, equipment anomaly detection history, and the like, and maintenance and arrangement of spare machines are proposed as necessary. For anomaly detection, when shipping volume, equipment operation rate, worker's workload, inventory amount, delivery delay, energy consumption, IoT sensor data, or the like significantly deviates from a past trend or a set threshold, the generative AI automatically issues an alert and notifies a field staff member and a manager. For risk scenario analysis, the generative AI executes simulation for a plurality of scenarios set by a field staff member or a manager, such as “how much delivery delay occurs when a typhoon approaches”, “how many additional personnel are required during a large-scale sale”, “alternative delivery route when traffic regulation occurs”, “recovery plan when equipment failures occur simultaneously and frequently”, “countermeasure when demand rapidly increases due to a social event”, and “cost impact when a new regulation is introduced”, and automatically generates an optimal countermeasure and resource allocation plan. The generative AI also has a self-learning function, and automatically optimizes parameters and structures of a model and continuously improves prediction accuracy and an optimization algorithm by incorporating feedback from a user, new performance data, external environment change data, response history when a system failure occurs, judgment trends of field staff members, past decision-making results, and the like. For example, when a divergence between actual demand and a prediction value is large, cause analysis is automatically executed, and re-learning of a model and addition/deletion of feature amounts are automatically performed. An execution result of a worker allocation plan and a productivity index in the field are matched, and parameters of an allocation algorithm are automatically adjusted. An execution result of a delivery plan and a delivery delay occurrence rate are matched, and a risk evaluation model is automatically updated. Specifically, the generative AI processing unit receives a preprocessed multidimensional tensor as input. The generative AI processing unit executes a hybrid neural network combining a long short-term memory network and a self-attention mechanism in demand prediction. The neural network receives a one-dimensional array indicating shipping performance for the past 365 days, a binary vector indicating presence or absence of promotion, and a continuous value vector indicating weather data as input data. The neural network combines these input vectors, and calculates a 256-dimensional hidden state vector. The neural network generates a 30-dimensional numerical vector indicating daily demand prediction values for the next 30 days as output data. The generative AI processing unit executes a reinforcement learning agent based on a Markov decision process in inventory optimization. The reinforcement learning agent receives a current inventory amount and a demand prediction vector as a state vector. The reinforcement learning agent selects an ordering amount of each product as an action space. The reinforcement learning agent sets minimization of a sum of inventory storage cost and shortage penalty as a reward function. The reinforcement learning agent updates weights of a policy network using a proximal policy optimization algorithm, and outputs a vector indicating an optimal ordering amount. The generative AI processing unit executes an approximate solution algorithm for a traveling salesman problem combined with a graph neural network in delivery plan optimization. The algorithm receives graph structure data composed of delivery destination nodes and road edges as input. The algorithm assigns predicted required time and cost as a weight of each edge. The algorithm generates a node sequence of an optimal delivery route that minimizes total delivery cost as output. The generative AI processing unit executes a mixed integer linear programming solver in worker allocation optimization. The solver receives a skill matrix of workers, a shift request vector, and a predicted workload vector of each area as input. The solver outputs an optimal allocation matrix that minimizes total labor cost while satisfying constraint conditions. The generative AI processing unit executes an autoencoder model in anomaly detection. The model calculates a reconstruction error of input data using a latent space representation learned from a sensor data stream in a normal state. The model outputs a binary flag indicating an anomaly when the reconstruction error exceeds a dynamically set threshold. The processing method replaces a decision-making process based on human rules of thumb with a strict mathematical optimization process. The processing method mathematically models a complex nonlinear relationship in a high-dimensional data space. With this configuration, the system brings about a technical effect of dramatically reducing operation cost of a logistics center and eliminating waste in resource allocation. The system is applicable to use cases requiring optimization under complex constraint conditions, such as dynamic routing of last-mile delivery and cooperative control of a robot group in an automated warehouse. The generative AI processing unit activates an online learning module, calculates an error gradient between a prediction value and a performance value, and updates weight parameters of a model in real time.

The decision-making support unit operates on the server, automatically generates decision-making plans such as a resource allocation plan, a worker shift plan, an equipment operation plan, a delivery route plan, a countermeasure at the time of anomaly occurrence, a risk avoidance measure, a cost reduction plan, a service quality improvement plan, KPI achievement degree prediction, a field improvement proposal, emergency response manual generation, and field education scenario generation based on a future prediction result and a scenario simulation result by the generative AI processing unit, and presents the decision-making plans to a field staff member and a manager in real time through the user interface unit. For example, in the logistics division, an optimal additional order amount, a delivery plan, an inventory movement plan, and an emergency countermeasure are automatically calculated in consideration of predicted demand and current inventory amount, warehouse capacity, delivery cost, lead time, weather risk, traffic conditions, skill distribution of workers, equipment operation status, and the like. As a worker allocation plan, experienced workers are intensively allocated in a time zone when shipping volume rapidly increases, and conversely, personnel are reduced in a slack time zone, thereby achieving both labor cost and work efficiency. As an equipment operation plan, timing when an operation rate of a forklift increases is grasped in advance, and when failure risk is high, maintenance can be planned ahead of schedule. As a delivery route plan, an optimal route considering traffic congestion and road regulation is automatically proposed, and an alternative route is immediately presented in an emergency. As a countermeasure at the time of anomaly occurrence, a countermeasure is immediately presented when shipping volume exceeds twice a normal level, when an equipment operation rate abnormally decreases, when a workload of a worker becomes excessive, or the like. As a risk avoidance measure, delivery delay risk when a typhoon approaches, an additional personnel arrangement plan during a large-scale sale, and the like are automatically generated. As KPI achievement degree prediction, target achievement degrees such as field productivity, cost, delivery time compliance rate, and quality index are predicted, and when unachieved risk is high, an improvement plan is automatically presented. As a field improvement proposal, past work history and error occurrence patterns are analyzed, and a review of work procedures and an optimization plan for equipment arrangement are automatically generated. As emergency response manual generation, specific response procedures for field staff members are automatically created based on past failure occurrence history and response history. As field education scenario generation, AI automatically generates an education scenario and training materials in line with actual conditions in the field. Specifically, the decision-making support unit operates on a distributed computing environment composed of a plurality of computing nodes. The decision-making support unit receives a high-dimensional prediction tensor and probability distribution data output from the generative AI processing unit. The decision-making support unit executes a hybrid inference engine combining a mathematical optimization algorithm and a reinforcement learning agent with these prediction data as input. The hybrid inference engine includes a deep reinforcement learning model based on a Markov decision process. The deep reinforcement learning model defines a state space, an action space, and a reward function. Input data to the deep reinforcement learning model is a current state vector. This state vector includes a numerical array indicating an inventory amount of each base, a multidimensional matrix indicating a skill level of a worker, and a binary vector indicating an operation state of equipment. For example, the state vector is configured as a 1024-dimensional vector concatenating elements such as an inventory amount of 500 at base A, a picking skill score of 0.8 of worker B, and an operation flag of 1 of forklift C. The deep reinforcement learning model processes the input state vector by a multilayer perceptron network. The multilayer perceptron network applies a ReLU activation function in each hidden layer. The deep reinforcement learning model calculates an optimal policy that maximizes an action value function. Output data from the deep reinforcement learning model is a probability distribution vector indicating a selection probability of each action in the action space. For example, the output data is a vector including numerical values such as a probability of 0.85 for performing additional ordering, a probability of 0.12 for shifting personnel, and a probability of 0.03 for stopping equipment. The decision-making support unit selects an action having the highest expected reward based on this probability distribution vector. Furthermore, the decision-making support unit inputs the selected action to a constrained nonlinear optimization solver. The nonlinear optimization solver sets a budget upper limit, a working hour upper limit based on the Labor Standards Act, and a physical warehouse capacity as constraint conditions. The nonlinear optimization solver searches for a parameter that minimizes or maximizes an objective function using a gradient descent method. Output data from the nonlinear optimization solver is an optimized resource allocation matrix and shift schedule tensor. For example, the output data is structured data including a worker ID, a start time, an end time, and an assigned task ID. The decision-making support unit inputs these structured data to a large language model. The large language model converts the structured data into a natural language text. Output data from the large language model is text data of an emergency response manual and a field improvement proposal understandable by a field staff member. For example, the output data is a paragraph text indicating a delivery route change procedure accompanying approach of a typhoon. The decision-making support unit integrates the generated text data and structured data, and generates a decision-making plan payload in JSON format. The decision-making support unit transmits this decision-making plan payload to the user interface unit. The decision-making support unit calculates an expected effect score of the generated decision-making plan as subsequent processing. When the expected effect score falls below a preset threshold, the decision-making support unit automatically triggers recalculation of an alternative scenario. With this configuration, the system derives a mathematically supported optimal solution in milliseconds from millions of combinations that cannot be intuitively processed by humans. As a result, the system exhibits a technical effect of dramatically improving accuracy and speed of decision-making while eliminating waste of computational resources. The present technology realizes dynamic optimization of resources in use cases such as complex supply chain management and production line control of a large-scale factory.

The user interface unit operates on the terminal, and a user accesses the server from the terminal and can operate a dashboard, a report, a scenario setting screen, a decision-making plan presentation screen, a feedback input screen, a notification receiving screen, a history reference screen, a report output screen, an alert receiving screen, a KPI monitoring screen, a field improvement proposal screen, an education scenario browsing screen, and the like. For example, a field staff member can confirm demand prediction and an inventory optimization plan of his/her own division, change scenario conditions as necessary, and input feedback to the decision-making plan. A manager can overlook an overall resource allocation status and risk scenarios, and perform adoption/modification/rejection of a decision-making plan, change of scenario conditions, input of feedback, and the like. A field education staff member can browse an education scenario and training materials generated by AI, and utilize them for field education. Specifically, the user interface unit is implemented as a client-side application operating by utilizing a processor and a memory of the terminal. The user interface unit is constructed by utilizing virtual DOM technology and WebAssembly. The user interface unit parses the decision-making plan payload received from the server. The user interface unit executes drawing processing by hardware acceleration utilizing a graphics processing unit based on the parsed data. The user interface unit renders high-dimensional data and complex scenario simulation results on a screen as a three-dimensional graph or a heat map. The user interface unit detects an input operation from a user via an event listener. Input data to the user interface unit is coordinate data from a touch panel, keystroke data from a keyboard, and voice waveform data from a microphone. For example, the input data is an XY coordinate value when a specific graph element on the screen is tapped, or a numerical input string for changing scenario conditions. The user interface unit serializes these input data into a structured JSON object. The user interface unit asynchronously transmits the serialized data to the server via a WebSocket protocol or a RESTful API. The user interface unit formats feedback input by the user to the decision-making plan as teacher data. The user interface unit transmits this teacher data to the generative AI processing unit on the server. The generative AI processing unit executes online learning or fine-tuning using the received teacher data. Output data from the user interface unit is a request payload and a feedback data set to the server. For example, the output data is a data set including a category ID and a text comment indicating a reason why the user rejected the proposal. The user interface unit displays a loading indicator on a part of the screen until a response from the server is received as subsequent processing, and prevents duplicate operations by the user. With this configuration, the system decentralizes rendering load to the client terminal. As a result, the system exhibits a technical effect of significantly reducing CPU load and memory consumption of the server. In addition, the system minimizes response delay to the user while suppressing consumption of network bandwidth by combining asynchronous communication and differential drawing technology. The present technology provides an extremely smooth operation experience in use cases such as a monitoring dashboard for financial transactions requiring real-time performance and a monitoring system for equipment operation status in a factory.

The notification receiving unit distributes alerts and updates of decision-making plans from the server, notifications of scenario simulation results, warnings at the time of system failure occurrence, warnings of KPI non-achievement risks, notifications of field improvement proposals, update notifications of educational scenarios, and the like to a user terminal in real time, enabling a user to respond promptly. For example, when a sign of a sudden increase in demand is detected, the notification receiving unit immediately notifies a terminal of a person in charge of a logistics division, and prompts an additional order and a review of a delivery plan. When an equipment failure risk increases, the notification receiving unit transmits a warning to a person in charge of equipment management, and prompts a reexamination of a maintenance plan. When a KPI non-achievement risk increases, the notification receiving unit transmits a warning to a manager, and prompts an execution of an improvement plan. Specifically, the present notification receiving unit is implemented as a daemon program resident as a background process of the terminal. The present notification receiving unit maintains a persistent connection with the server using MQTT, which is a lightweight messaging protocol, or a dedicated push notification service. The present notification receiving unit receives a notification payload transmitted from the server in real time. Input data to the present notification receiving unit is a notification payload in a binary format or a JSON format distributed from the server. This notification payload includes an event ID, an importance score, a message text, and a time stamp. For example, the input data is a data object in which the event ID is 999, the importance score is 0.95, the message text is equipment anomaly detection, and the time stamp is UNIX epoch seconds. The present notification receiving unit parses the received notification payload and extracts the importance score. The present notification receiving unit compares the extracted importance score with a plurality of preset thresholds. When the importance score exceeds a threshold of a highest alert level, the present notification receiving unit calls an interrupt API of an operating system. The present notification receiving unit drives a vibration motor of the terminal in a specific pattern, and simultaneously forcibly displays a modal pop-up window on a screen. When the importance score is low, the present notification receiving unit only performs a silent addition to a notification center. Output data from the present notification receiving unit is a hardware control command to the operating system and a redraw trigger of a UI component. For example, the output data is a command to turn on vibration for 500 milliseconds and an instruction to draw a red warning icon. As a subsequent process, the present notification receiving unit records a time when the user opens the notification and an action content. The present notification receiving unit asynchronously returns this opening history data to a log management unit of the server. With this configuration, the present system minimizes an operating time of a communication module of the terminal by adopting a push method instead of a polling method. As a result, the present system exhibits a technical effect of preventing wasteful consumption of a network bandwidth while dramatically reducing battery consumption of the terminal. In addition, the present system optimizes a cognitive load of the user by performing dynamic interrupt control according to the importance. The present technology realizes reliable and prompt information transmission in use cases such as a patient condition alert system in a medical field where every moment counts and an emergency evacuation instruction system at the time of a wide-area disaster.

The local cache unit temporarily stores recent data and frequently referred data on the terminal, enabling the user to smoothly use the system even when a network delay or a temporary communication disconnection occurs. For example, even when a field staff member uses the terminal in a place where a network environment is unstable, such as a warehouse or a delivery site, the field staff member can immediately refer to a recent demand prediction, an inventory optimization plan, an emergency response manual, an educational scenario, and the like. Specifically, the present local cache unit is implemented as an embedded relational database or a key-value store constructed on a non-volatile storage of the terminal. The present local cache unit encrypts and stores the data received from the server in the terminal. The present local cache unit dynamically manages a capacity of a cache memory using an LRU algorithm or an LFU algorithm. When an upper limit of a storage capacity is reached, the present local cache unit automatically discards data in order from lowest access frequency. Input data to the present local cache unit is a decision-making plan downloaded from the server, a lightweight weight parameter of a prediction model, and text data of a manual. For example, the input data is a demand prediction time-series array for the latest 24 hours and a quantized neural network model file for edge inference. The present local cache unit constantly monitors a status of a network interface. When detecting a communication disconnection, the present local cache unit immediately switches a data reference destination of the entire system from the server to a local storage. In an offline state, the present local cache unit executes local inference on a processor of the terminal using the stored lightweight model. Output data from the present local cache unit is a JSON object read from the local storage and a prediction score by the local inference. For example, the output data is a coordinate list of an alternative delivery route calculated under an offline environment. As a subsequent process, the present local cache unit records an operation history and a data change performed by the user during offline in a local transaction log. When detecting that communication is recovered, the present local cache unit executes a merge algorithm in the background. The present local cache unit transmits a local change difference to the server, and when a conflict occurs, applies a resolution rule based on a time stamp to synchronize the data. With this configuration, the present system enables continuous business execution without depending on the network environment. As a result, the present system exhibits a technical effect of reducing redundant requests to the server and shortening a response speed of the entire system to a millisecond order. The present technology dramatically improves availability of the system in use cases such as a business support system using a mobile terminal under an environment where a radio wave condition is extremely unstable, such as an underground warehouse or a construction site in a mountainous area.

The log management unit operates on the server, and records and manages detailed logs of all data acquisition, preprocessing, learning and inference of an AI model, decision-making plan generation, user operation, feedback, system error, security event, KPI monitoring, field improvement proposal generation, educational scenario generation, and the like in chronological order. This enables traceability of the system, audit response, failure analysis, operation improvement, compliance response, effect measurement of field education, and the like. For example, version management of the AI model, data acquisition date and time, user's decision-making history, detailed log at the time of system failure occurrence, access history from the outside, usage history of the educational scenario, and the like are recorded in detail. Specifically, the present log management unit is implemented as a distributed time-series database and an immutable storage system constructed independently in a server cluster. The present log management unit receives a log event asynchronously transmitted from each module in the system via a message queuing system. Input data to the present log management unit is a structured log event object generated in each processing step. This log event object includes a time stamp, a module ID, an event type, a processing time, a memory consumption amount, and a hash value of a payload. For example, the input data is data in a JSON format in which the time stamp is 12:00:00 on Oct. 1, 2023, the module ID is an AI inference unit, the event type is model inference completion, the processing time is 45 milliseconds, and the memory consumption amount is 512 MB. The present log management unit applies a data compression algorithm to the received log event object. The present log management unit writes the compressed data to a specific partition of the time-series database. In order to prevent data falsification, the present log management unit applies a cryptographic hash function to each log entry, and constructs a hash chain by including a hash value of a previous log entry. Output data from the present log management unit is a binary log file persisted in a storage and aggregated report data for audit. For example, the output data is time-series vector data indicating an occurrence frequency of a system error in a specific period. As a subsequent process, the present log management unit periodically inputs the accumulated log data to a machine learning model for anomaly detection. The present anomaly detection model automatically detects a sign of system performance degradation or a security threat from a log pattern. When detecting an anomaly, the present log management unit issues an immediate alert to a system administrator. With this configuration, the present system records a huge amount of log data at high speed and safely without blocking a main business processing thread. As a result, the present system exhibits a technical effect of completely eliminating an I/O bottleneck and guaranteeing complete traceability and data integrity while maintaining a processing throughput of the entire system. The present technology provides a data management infrastructure with high evidentiary value in use cases such as a transaction audit system of a financial institution requiring strict compliance and a black box recording device of an autonomous driving system.

The security management unit operates on the server, and comprehensively executes data encryption, access authority management, user authentication, communication path encryption, unauthorized access detection, malware countermeasure, data backup, disaster recovery response, personal information protection response, security monitoring of a field terminal, copyright management of an educational scenario, and the like. For example, highly confidential shipping performance data and worker data including personal information are subjected to strong encryption both during storage and during transfer, and access authority is strictly controlled. When unauthorized access from the outside or an abnormal operation is detected, the security management unit immediately notifies a manager, and automatically executes access blocking and data isolation as necessary. As the copyright management of the educational scenario, a usage history and a modification history of a teaching material generated by AI are recorded to prevent unauthorized use. Specifically, the present security management unit executes data protection using an advanced encryption algorithm. The present security management unit applies an advanced encryption standard method having a key length of 256 bits to stored data. The present security management unit applies a transport layer security protocol to a communication path. The present security management unit executes a multi-factor authentication process in user authentication. The present security management unit generates an authentication vector combining biometric authentication data and a one-time password. The present security management unit transmits the authentication vector to an authentication server. The present security management unit implements an anomaly detection neural network for unauthorized access detection. The present anomaly detection neural network adopts an autoencoder architecture. The present security management unit generates a multidimensional time-series tensor including packet header information, a payload size, and an access frequency of network traffic. The present security management unit inputs the multidimensional time-series tensor to the present anomaly detection neural network. The present anomaly detection neural network compresses an input tensor into a low-dimensional latent space. The present anomaly detection neural network reconstructs an original tensor from the latent space. The present anomaly detection neural network calculates a reconstruction error between the input tensor and a reconstructed tensor. The present security management unit outputs the reconstruction error as an anomaly score. The present security management unit determines whether the anomaly score exceeds a preset dynamic threshold. When detecting an excess, the present security management unit immediately blocks the communication session. The present security management unit registers a network identification address to be blocked in a blacklist database. The present security management unit utilizes a distributed ledger technology in the copyright management of the educational scenario. The present security management unit calculates a hash value of generated teaching material data. The present security management unit records metadata including the hash value, a generation date and time, and a creator identifier as a transaction. The present security management unit synchronizes the transaction with a plurality of nodes on a distributed network. Thereby, the present system makes data falsification mathematically impossible. The present system minimizes an information leakage risk. The present system exhibits a technical effect of dramatically improving availability and integrity of the entire system. The present technology is particularly effective in application fields requiring extremely high confidentiality, such as a transaction system of a financial institution and an electronic medical record system of a medical institution.

As described above, in the embodiment of the present invention, a wide variety of data inside and outside a logistics center are integrated in real time, highly accurate future prediction, optimization, anomaly detection, risk scenario analysis, field improvement proposal, and educational scenario generation by generative AI are automatically and continuously executed, and a field staff member and a manager are enabled to make a prompt and optimal decision-making based on the results. Furthermore, feedback and performance data from a user are automatically reflected in the generative AI, and accuracy of a model and an optimization algorithm continuously evolve, thereby simultaneously realizing operational efficiency improvement, cost reduction, risk reduction, service quality improvement, and advancement of field education of the logistics center, and enabling a transition from conventional operation depending on human hands and experience to advanced logistics management by data-driven and AI optimization. Specifically, the present system maps unstructured data and structured data acquired from a plurality of heterogeneous data sources to a common multidimensional vector space. The present system executes a large language model equipped with a self-attention mechanism and a time-series prediction model in parallel on the multidimensional vector space. The present system acquires a daily shipping volume array for the past 365 days, an hourly weather data tensor, and a numerical vector indicating a skill level of a worker as input data. The present system converts these input data into a feature tensor via normalization processing and tokenization processing. The present system inputs the feature tensor to the present large language model. The present large language model extracts a hidden correlation between features using a multi-layer transformer encoder block. The present large language model generates a numerical array indicating a daily predicted shipping volume for the next one week and a score vector indicating a probability distribution of a personnel shortage risk as output data. The present system inputs the output data to a subsequent optimization solver. The present optimization solver calculates an optimal personnel allocation matrix using mixed integer linear programming. The present system acquires a correction instruction and feedback of a performance value input from a user terminal as an error signal. The present system fine-tunes a weight parameter of the present large language model by an error backpropagation method using the error signal. The present system continuously updates a decision-making policy using a reinforcement learning algorithm. The present system sets minimization of a logistics cost and maximization of an on-time delivery rate as a reward function. The present system learns an optimal action-value function using a state transition model based on a Markov decision process. Thereby, the present system eliminates a conventional operation method depending on human intuition and rules of thumb. The present system realizes extremely highly accurate prediction and control while suppressing consumption of computer resources by pure mathematical optimization processing in a high-dimensional data space. The present system exhibits a technical effect of dramatically improving operational efficiency of the logistics center. The present technology is extremely useful in application fields such as a large-scale e-commerce fulfillment center and a global supply chain management base.

### System Configuration

The system according to the present embodiment comprises a data integration unit, a generative AI processing unit, a decision-making support unit, a user interface unit, a notification receiving unit, a local cache unit, a log management unit, and a security management unit. The data integration unit collects an extremely wide variety of data, such as shipping performance data inside and outside a logistics center, inventory data, receipt and shipment history data, delivery destination information, weather data, traffic data, worker operation data, equipment operation history data, external event data, shift tables, maintenance records, and IoT sensor data, by means of API linkage, file transfer, database connection, IoT device linkage, external data provider linkage, Web scraping, and the like, and centrally integrates the data based on time-series information, attribute information, and ID information, including, for example, daily and hourly shipping volumes, inventory amounts by product, delivery delay histories, expiration date management data, congestion indices of major roads, work histories for each worker, operation histories of forklifts, social event information, temperature and humidity sensor values, and baggage weight sensor values. The data integration unit automatically executes preprocessing such as missing data complementation, anomaly detection, standardization of units and scales, deduplication of data, data type conversion, data reliability evaluation, anonymization and masking, encryption, structured conversion of unstructured data, object detection and anomaly detection by image recognition, and work status grasping by video analysis, and realizes, for example, unification of inventory data managed in different units, real-time stream integration of IoT sensor data, keyword extraction of worker memos, and anomaly detection of surveillance camera videos. Specifically, the present data integration unit asynchronously receives tens of thousands of streaming data per second using a distributed messaging system. The present data integration unit temporarily stores the received raw data in an in-memory data grid. The present data integration unit extracts a named entity from unstructured text data using a natural language processing model. The present data integration unit extracts bounding box coordinates of a worker and a forklift from a video frame of a surveillance camera using a convolutional neural network. The present data integration unit acquires a color image tensor of 1024 pixels square and a vibration sensor time-series array with a sampling rate of 100 hertz as input data. The present data integration unit executes normalization of pixel values and data augmentation processing on the image tensor. The present data integration unit applies a fast Fourier transform to the time-series array and extracts a feature in a frequency domain. The present data integration unit combines these preprocessed data as a feature vector. The present data integration unit utilizes a generative adversarial network for missing data complementation. The present generative adversarial network is composed of a generator and a discriminator. The present generator receives a data vector including a missing value as an input, and generates a pseudo complete data vector. The present discriminator discriminates between an actual complete data vector and a pseudo complete data vector. The present data integration unit realizes extremely natural missing data complementation by causing both to learn competitively. The present data integration unit executes an isolation forest algorithm for anomaly detection. The present data integration unit calculates an isolation degree of each data point, and removes a data point exceeding a threshold as noise. The present data integration unit stores the integrated data in a graph database. The present graph database expresses a relationship between entities as an edge. Thereby, the present system enables a complex network structure of a supply chain to be efficiently searched on a computer. The present system significantly shortens a calculation time required for preprocessing of data. The present system exhibits a technical effect of improving inference accuracy of a subsequent artificial intelligence model. The present technology becomes an indispensable infrastructure technology in application fields such as production line monitoring in a smart factory and a real-time control system of a wide-area transportation network.

The generative AI processing unit executes demand prediction, inventory optimization, delivery plan optimization, worker allocation optimization, equipment operation prediction, anomaly detection, risk scenario analysis, field improvement proposal, educational scenario generation, and the like in real time and automatically by combining a machine learning algorithm, a deep learning model, a natural language processing model, a reinforcement learning model, an anomaly detection model, a clustering model, an optimization algorithm, and the like with the integrated and preprocessed data as input. For example, the generative AI processing unit predicts future shipping demand using a time-series prediction model using LSTM or Transformer, and detects a sudden demand increase risk and a shortage risk in advance. The generative AI processing unit calculates an optimal inventory amount in consideration of a demand prediction result, an inventory turnover rate, and a storage space constraint, and prevents excess inventory and shortage. In a delivery plan, the generative AI processing unit automatically generates an optimal delivery route and schedule in consideration of a shipping volume prediction, a traffic condition, the number of vehicles, road regulation information, a delivery cost, a delivery priority, and the like. In worker allocation, the generative AI processing unit generates an optimal allocation plan by clustering and an optimization algorithm based on a shipping volume, an inventory fluctuation, a worker skill, a shift request, a health condition, qualification information, and the like, and achieves both a labor cost and work efficiency. In equipment operation prediction, the generative AI processing unit predicts an operation rate and a failure risk based on an equipment operation history, a maintenance record, a consumable part life prediction, an anomaly detection history, and the like, and proposes maintenance and spare machine arrangement. In anomaly detection, when a shipping volume, an equipment operation rate, a worker workload, an inventory amount, a delivery delay, an energy consumption amount, IoT sensor data, and the like deviate from thresholds, the generative AI processing unit issues an alert and notifies a field staff member and a manager. In risk scenario analysis, the generative AI processing unit simulates a plurality of scenarios, such as a delivery delay when a typhoon approaches, an additional personnel requirement amount during a large-scale sale, an alternative route during traffic regulation, a recovery plan during simultaneous equipment failure, a countermeasure during a sudden demand increase due to a social event, and a cost impact when a new regulation is introduced, and automatically generates an optimal countermeasure and resource allocation plan. In a field improvement proposal, the generative AI processing unit analyzes a past work history and an error occurrence pattern, and generates a work procedure review and an equipment allocation optimization plan. In educational scenario generation, the generative AI processing unit automatically generates an educational scenario and a training material in line with an actual situation of a field. Specific examples of a prompt sentence to be read by the generative AI include “Predict shipping demand for the next 14 days with high accuracy based on shipping performance, inventory amount, weather, traffic, and event information for the past two years, and if there is a sudden demand increase risk, output its factor and countermeasure together”, “Automatically generate the number of workers required during a large-scale sale period next week and an optimal shift allocation plan in consideration of a past work history and shipping performance”, “Predict an equipment operation rate and a failure risk for the next one week based on an equipment operation history and a maintenance record, and propose a necessary maintenance plan”, “Output an anomaly detection alert and a recommended countermeasure when a shipping volume exceeds twice a normal volume”, and “Simulate a delivery delay risk and an alternative delivery route plan when a typhoon approaches”. Specifically, the present generative artificial intelligence processing unit adopts an ensemble architecture in which a plurality of neural networks are hierarchically combined. The present generative artificial intelligence processing unit acquires a one-dimensional time-series array indicating a daily shipping volume for the past 730 days, a 50-dimensional embedding vector indicating an attribute of each product, and a 10-dimensional numerical vector indicating a weather condition as input data. The present generative artificial intelligence processing unit combines these input data and inputs them to a transformer model equipped with a multi-head self-attention mechanism. The present transformer model executes an inner product attention calculation using a query matrix, a key matrix, and a value matrix on an input tensor to which positional encoding is added. The present transformer model extracts a long-term dependency and a seasonal pattern. The present transformer model generates a 14-dimensional numerical vector indicating a daily predicted shipping volume for the next 14 days and a probability distribution tensor indicating a confidence interval of each predicted value as output data. The present generative artificial intelligence processing unit inputs the prediction result to a subsequent reinforcement learning agent. The present reinforcement learning agent learns an optimal inventory replenishment policy using a deep Q-network algorithm. The present reinforcement learning agent uses a current inventory level and a predicted demand amount as a state space. The present reinforcement learning agent uses an order amount and an order timing as an action space. The present reinforcement learning agent uses a sum of a negative value of an inventory holding cost and a negative value of a shortage penalty as a reward function. The present reinforcement learning agent updates an action-value function by an error backpropagation method based on a Bellman equation. The present generative artificial intelligence processing unit executes a genetic algorithm for delivery plan optimization. The present generative artificial intelligence processing unit expresses each delivery route as a chromosome. The present generative artificial intelligence processing unit iteratively applies crossover processing and mutation processing, and searches for an optimal solution that minimizes a total delivery distance and a total delivery time. The present generative artificial intelligence processing unit generates a risk scenario analysis report in natural language using a large language model. The present large language model autoregressively predicts an appearance probability of a next word based on an input prompt sentence and context data. The present large language model generates structured text data including a bulleted list of risk factors and a specific procedure manual of a recommended countermeasure as output data. Thereby, the present system simultaneously processes a huge number of variables exceeding human cognitive limits. The present system derives a global optimal solution without falling into a local optimal solution. The present system exhibits a technical effect of dramatically reducing an operation cost of an entire logistics network. The present technology has extremely high usefulness in application fields such as crew scheduling of an airline having complex constraint conditions and a traffic signal control system of a large-scale city.

The decision-making support unit automatically generates decision-making plans such as a resource allocation plan, a worker shift plan, an equipment operation plan, a delivery route plan, a countermeasure at the time of anomaly occurrence, a risk avoidance measure, a cost reduction plan, a service quality improvement plan, a KPI achievement degree prediction, a field improvement proposal, an emergency response manual generation, and an educational scenario generation based on a future prediction result and a scenario simulation result by the generative AI processing unit, and presents the decision-making plans to a field staff member and a manager in real time through a user interface unit. For example, the decision-making support unit proposes an additional order and a delivery plan review at the time of a sudden demand increase, intensively allocates an experienced worker in a busy time zone in worker allocation, plans maintenance ahead of schedule in a high operation period in an equipment operation plan, and proposes an optimal route avoiding congestion and regulation in a delivery route plan. The decision-making support unit presents an immediate countermeasure at the time of anomaly occurrence, generates an advance preparation plan at the time of a typhoon or a disaster as a risk avoidance measure, and presents an improvement plan when a KPI non-achievement risk is high. The decision-making support unit automatically generates optimization of a work procedure and equipment allocation in a field improvement proposal, a specific response procedure at the time of failure occurrence in an emergency response manual, and a training material in line with a field issue in an educational scenario. Specifically, the present decision-making support unit receives a multidimensional prediction tensor and probability distribution data output from the generative artificial intelligence processing unit. The present decision-making support unit constructs a decision-making matrix by combining a rule-based inference engine and a fuzzy logic controller. The present decision-making support unit acquires a numerical vector indicating a skill level of each worker, a time-series score indicating a fatigue degree, and a categorical variable indicating a priority of each task as input data. The present decision-making support unit inputs these input data to a solver of a constraint satisfaction problem. The present solver generates an executable shift allocation matrix satisfying all labor laws and business requirements using a backtracking algorithm and a constraint propagation method. The present decision-making support unit generates a plurality of alternatives, and calculates an evaluation score based on an objective function for each. The present decision-making support unit extracts top three alternatives having highest evaluation scores. The present decision-making support unit generates structured data including a specific action plan of each alternative as output data. The present structured data includes an execution date and time of an action, an identifier of a target resource, and a numerical value of an expected cost-effectiveness. The present decision-making support unit transmits the structured data to a drawing engine of the user interface unit. The present decision-making support unit searches a vector database storing a past incident response history in generating a countermeasure at the time of anomaly occurrence. The present decision-making support unit calculates a cosine similarity between a feature vector indicating a current abnormal state and a past case vector in the database. The present decision-making support unit extracts a past case in which the similarity exceeds a predetermined threshold. The present decision-making support unit inputs a response procedure of the extracted case to a large language model, and dynamically generates an emergency response manual in which a context is adjusted to suit a current situation. Thereby, the present system completes a complex planning work, which a human manager took several hours to perform, in units of several milliseconds. The present system completely eliminates an opportunity loss due to a delay in decision-making. The present system exhibits a technical effect of promoting standardization of business and elimination of personalization. The present technology is extremely effective in application fields such as an automatic planning system of a wide-area evacuation plan at the time of a disaster and a dynamic allocation system of an operating room and medical staff in a large-scale hospital.

The user interface unit operates on the terminal, and the user can operate a dashboard, a report, a scenario setting screen, a decision-making plan presentation screen, a feedback input screen, a notification receiving screen, a history reference screen, a report output screen, an alert receiving screen, a KPI monitoring screen, a field improvement proposal screen, an educational scenario browsing screen, and the like. A field staff member can confirm a demand prediction and an inventory optimization plan, change a scenario condition, and input feedback to a decision-making plan, and a manager can overlook an overall resource allocation status and a risk scenario, and perform adoption, correction, and rejection of a decision-making plan, change of a scenario condition, input of feedback, and the like. A person in charge of field education can browse an educational scenario and a training material generated by AI, and utilize them for field education. Specifically, the present user interface unit adopts a single-page application architecture, and exchanges data with the server by asynchronous communication. The present user interface unit establishes an always-connected bidirectional communication channel with the server using a WebSocket protocol. The present user interface unit minimizes a drawing update of a screen using a virtual document object model. The present user interface unit acquires a screen touch coordinate of the user, a mouse click event, and a keyboard input stroke as input data. The present user interface unit captures these input events by an event listener, and activates a corresponding action dispatcher. The present user interface unit visualizes equipment allocation and an inventory status in the logistics center as a digital twin using a three-dimensional graphics library. The present user interface unit draws a current position and a predicted movement route of each inventory pallet as a color-coded polygon model. When the user changes a parameter of a scenario condition with a slider, the present user interface unit immediately transmits the changed value to the server as a numerical vector. The present user interface unit receives data of a recalculation result returned from the server. The present user interface unit renders an updated prediction graph, a heat map, and an alert badge on the screen as output data. The present user interface unit collects line-of-sight movement data and an operation history of the user in the background. The present user interface unit transmits the operation history data to the server as an operation log tensor. Thereby, the present system provides an extremely highly responsive operation feeling while suppressing consumption of a network bandwidth. The present system converts complex multidimensional data into intuitively understandable visual information. The present system exhibits a technical effect of significantly reducing a cognitive load of the user and preventing an erroneous operation. The present technology is an indispensable human-machine interface technology in application fields such as a radar information integrated display system for an air traffic controller and a plant operation monitoring console of a power plant.

The notification receiving unit distributes alerts and updates of decision-making plans from the server, notifications of scenario simulation results, warnings at the time of system failure occurrence, warnings of KPI non-achievement risks, notifications of field improvement proposals, update notifications of educational scenarios, and the like to a user terminal in real time, enabling a user to respond promptly. For example, when a sign of a sudden increase in demand is detected, the notification receiving unit immediately notifies a terminal of a person in charge of a logistics division to prompt an additional order and a review of a delivery plan, transmits a warning to a person in charge of equipment management when an equipment failure risk increases, and transmits a warning to a manager to prompt execution of an improvement plan when a KPI non-achievement risk increases. Specifically, the present notification receiving unit realizes low-latency messaging using a push notification service protocol. The present notification receiving unit is resident as a background process, and receives a payload from the server even when the terminal is in a sleep state. The present notification receiving unit acquires, as input data, a structured payload including a notification type code, an integer value indicating an importance level, and a message body transmitted from the server. The present notification receiving unit analyzes the payload and executes an interrupt process according to the importance level. When the importance level is a maximum value, the present notification receiving unit programmatically cancels a silent mode of an operating system of the terminal. The present notification receiving unit transmits, as output data, a playback command of a warning sound having a specific frequency pattern and a forced lighting command of a screen to a hardware controller. The present notification receiving unit stores notification contents in a local database in chronological order. The present notification receiving unit generates an action intent when the user taps a notification. The present notification receiving unit passes the action intent to the user interface unit to immediately expand a related detailed screen. The present notification receiving unit returns a status flag indicating a notification arrival confirmation and a read state to the server. When a network connection is disconnected, the present notification receiving unit collectively acquires unreceived notifications at the time of connection recovery using a retransmission control algorithm. Thereby, the present system completely prevents omission of information transmission. The present system shortens a human initial response time in an emergency in milliseconds. The present system exhibits a technical effect of ensuring real-time performance of the entire system. The present technology plays an extremely important role in application fields such as an anomaly detection alert system for algorithmic trading in a financial market and a patient vital sign sudden change notification system in a medical field.

The local cache unit temporarily stores recent data and frequently referenced data on the terminal, enabling the user to smoothly use the system even when a network delay or a temporary communication disconnection occurs. Even when a field staff member uses the terminal in a place where a network environment is unstable, such as a warehouse or a delivery site, the field staff member can immediately refer to a recent demand prediction, an inventory optimization plan, an emergency response manual, an educational scenario, and the like. Specifically, the present local cache unit executes data management using a key-value store type embedded database engine. The present local cache unit generates a unique cache key using a hash function for a data object received from the server. The present local cache unit acquires, as input data, structured data of a prediction result acquired from the server and a time stamp indicating an expiration date of the data. The present local cache unit converts these data into a binary format by a serialization process. The present local cache unit writes the binary data to a designated sector on a flash memory. The present local cache unit constantly monitors a link state of a network interface card of the terminal. When detecting a communication disconnection, the present local cache unit intercepts a data request from an application. The present local cache unit searches a local storage using a cache key corresponding to the requested data. The present local cache unit deserializes the cached binary data as output data, and returns the original data object to the application. The present local cache unit manages a storage capacity using a least frequently used algorithm. When a storage usage amount reaches an upper limit threshold, the present local cache unit purges data blocks from a memory space in order from the oldest referenced data block. When communication is recovered, the present local cache unit activates a background thread to execute a differential synchronization process of data with the server. The present local cache unit detects a mismatch between local data and server data at high speed using a Merkle tree structure. Thereby, the present system prevents an application crash even under a poor communication environment. The present system completely guarantees user operation continuity. The present system exhibits a technical effect of reducing redundant requests to the server and saving a network bandwidth of the entire system. The present technology is extremely useful in application fields such as an autonomous control terminal of a construction machine operating in an underground space or a mountainous area, and a navigation system in a ship during an ocean voyage.

The log management unit records and manages detailed logs of all data acquisition, preprocessing, learning and inference of an AI model, decision-making plan generation, user operations, feedback, system errors, security events, KPI monitoring, field improvement proposal generation, educational scenario generation, and the like in chronological order, and records in detail version management of the AI model, data acquisition date and time, user decision-making history, detailed logs at the time of system failure occurrence, access history from the outside, usage history of educational scenarios, and the like, thereby enabling system traceability, audit response, failure analysis, operation improvement, compliance response, effect measurement of field education, and the like. Specifically, the present log management unit adopts a distributed log collection architecture and integrates log events asynchronously output from each module. The present log management unit acquires, as input data, a structured log message including an event type, a time stamp, a process identifier, and a payload transmitted from each processing unit. The present log management unit applies a data compression algorithm to the log message to minimize storage consumption. The present log management unit indexes and stores log data in a time-series database. The present log management unit records a hash value of an input tensor, a version identifier of a weight parameter of a used model, and an output probability distribution vector as a log related to an inference process of an artificial intelligence model. The present log management unit records a sequence of screen transitions, coordinate data of a button press, and a response time of a process in milliseconds as a user operation log. The present log management unit extracts a set of log entries matching a specific query condition as output data, and generates report data for auditing. The present log management unit applies an anomaly detection algorithm to a log stream. The present log management unit expresses an occurrence frequency of logs and an appearance pattern of error codes as a multidimensional vector. The present log management unit inputs the vector to a clustering model, and detects a cluster having an unusual pattern as a sign of an unknown system failure. In order to prevent falsification of log data, the present log management unit applies a cryptographic hash function to each log block and anchors it to a blockchain network. Thereby, the present system provides complete accountability for a judgment process of artificial intelligence that is likely to become a black box. The present system dramatically shortens a time required for root cause analysis at the time of failure occurrence. The present system exhibits a technical effect of mathematically proving reliability and transparency of the system. The present technology is an indispensable fundamental technology in application fields such as a driving record system of an autonomous driving vehicle and an algorithmic trading audit system of a financial institution.

The security management unit comprehensively implements data encryption, access authority management, user authentication, communication path encryption, unauthorized access detection, malware countermeasures, data backup, disaster recovery response, personal information protection response, security monitoring of field terminals, copyright management of educational scenarios, and the like, applies strong encryption to highly confidential shipping performance data and worker data including personal information both during storage and during transfer, strictly controls access authority, immediately notifies a manager when unauthorized access from the outside or an abnormal operation is detected, automatically executes access blocking and data isolation as necessary, and records a usage history and an alteration history of teaching materials generated by AI as copyright management of educational scenarios to prevent unauthorized use. Specifically, the present security management unit executes a dynamic verification process for all access requests based on a principle of a zero trust network architecture. The present security management unit acquires, as input data, a context vector including a user authentication credential, a network identification address of an access source, a device fingerprint, and an identifier of a requested resource. The present security management unit inputs the context vector to a risk evaluation neural network. The present risk evaluation neural network calculates a threat score of a current access request using a multilayer perceptron. The present security management unit generates, as output data, a control command for access permission, denial, or an additional authentication request based on the threat score. The present security management unit executes an encryption process by a public key infrastructure using elliptic curve cryptography on stored data. The present security management unit also applies homomorphic encryption technology to data being processed on a memory, enabling an inference operation of an artificial intelligence model while remaining in an encrypted state. The present security management unit cooperates with an endpoint behavior detection agent. The present security management unit collects a process activation history, an access pattern to a file system, and a registry change history on a terminal as a time-series tensor. The present security management unit inputs the time-series tensor to a recurrent neural network, and detects a behavior peculiar to ransomware or a zero-day attack. When detecting a threat, the present security management unit logically disconnects a network interface of the terminal, and prevents horizontal expansion of infection at a physical level. The present security management unit applies a digital watermarking algorithm for copyright protection of educational scenarios. The present security management unit embeds a unique tracking code in an invisible area of generated text or image data. Thereby, the present system prevents data leakage due to an internal crime or an advanced targeted attack. The present system exhibits a technical effect of maintaining confidentiality, integrity, and availability of information assets at a highest level. The present technology is extremely important in application fields such as a defense system handling national secrets and a data infrastructure of a research and development institution managing cutting-edge intellectual property.

As described above, the system according to the present embodiment integrates a wide variety of data inside and outside a logistics center in real time, automatically and continuously executes highly accurate future prediction, optimization, anomaly detection, risk scenario analysis, field improvement proposal, and educational scenario generation by generative AI, and enables a field staff member and a manager to make a prompt and optimal decision-making based on the results. Furthermore, by automatically reflecting feedback and performance data from a user to the generative AI and continuously evolving model accuracy and an optimization algorithm, operational efficiency improvement, cost reduction, risk reduction, service quality improvement, and advancement of field education of the logistics center are simultaneously realized, enabling a conversion from a conventional operation depending on human hands and experience to advanced logistics management by data-driven and AI optimization. Specifically, the present system constructs a distributed processing pipeline that cooperatively operates an edge computing node and a cloud computing cluster. The present system continuously takes in, as input data, multidimensional time-series stream data transmitted every second from thousands of Internet of Things sensors and structured data acquired from an external weather information provider. The present system converts these input data into a high-dimensional tensor on a feature space. The present system inputs the high-dimensional tensor to a hybrid architecture of a deep reinforcement learning model and a large language model. The present hybrid architecture executes spatial feature extraction by a convolutional layer and temporal feature extraction by a long short-term memory layer in parallel. The present system generates, as output data, a continuous value vector indicating an optimal inventory replenishment amount of each logistics base and a discrete value matrix indicating an optimal solution of personnel allocation. The present system directly transmits the output data as a control signal to a group control server of automated guided robots and a personnel management database. The present system implements an online learning algorithm. The present system calculates a mean square error between a predicted value and a performance value obtained in daily operation as a loss function. The present system updates a weight parameter of a model in real time using a stochastic gradient descent method. The present system aggregates only gradient information of a model learned at each base to a central server without sharing raw data among a plurality of logistics centers using federated learning technology. The present system updates a global model using the aggregated gradient information, and redistributes it to each base. Thereby, the present system establishes an autonomous control loop that self-adaptively evolves in response to a dynamic change in an environment. The present system exhibits a technical effect of monotonically increasing prediction accuracy of the entire system while optimizing consumption of computational resources. The present technology becomes a core technology supporting a next-generation social infrastructure in application fields such as an integrated management system of an urban infrastructure in a smart city and an automatic adjustment system of a supply and demand balance of a wide-area power grid.

### Implementation Steps

Step 1: Data Collection and Integration Shipping performance data inside and outside a logistics center, inventory data, receipt and shipment history data, delivery destination information, weather data, traffic data, worker operation data, equipment operation history data, external event data, shift tables, maintenance records, IoT sensor data, and the like are collected by various means such as API linkage, file transfer, database connection, IoT device linkage, external data provider linkage, and web scraping, and are centrally integrated based on time-series information, attribute information, and ID information. For example, shipping volume by day and time zone, inventory amount by product, delivery delay history, expiration date management data, congestion index of major roads, work history for each worker, operation history of a forklift, social event information, temperature and humidity sensor values, luggage weight sensor values, and the like are included and integrated. Specifically, the present system arranges a data collection agent in each data source, and extracts data using an asynchronous event-driven architecture. The present system acquires, as input data, tabular data extracted from a relational database, a binary payload transmitted from a sensor, and text data of a markup language scraped from a website. The present system maps these heterogeneous format data to a common data schema. The present system assigns a Coordinated Universal Time-based time stamp, latitude and longitude data indicating geospatial coordinates, and a unique universally unique identifier to each data record. The present system publishes the extracted data to a message queuing system. The present system loads the data into an in-memory data store using a subscriber process. The present system generates, as output data, a multidimensional data frame combining information from all data sources. The present system stores the data frame in a column-oriented distributed file system. The present system executes a schema verification algorithm in a process of data integration, and automatically detects a data type mismatch and a constraint violation. The present system isolates a record in which a violation is detected to a dead letter queue, and prevents contamination of a subsequent processing pipeline. Thereby, the present system converts petabyte-class big data into a state capable of being processed with extremely low latency. The present system exhibits a technical effect of eliminating data silos and dramatically improving data visibility of the entire system. The present technology is an indispensable data infrastructure technology in application fields such as a global supply chain integrated monitoring system of a multinational corporation and an electronic medical record integrated network among a plurality of hospitals.

Step 2: Data Preprocessing and Structuring Preprocessing such as missing data complementation, anomaly detection, standardization of units and scales, deduplication, data type conversion, data reliability evaluation, anonymization and masking, encryption, structured conversion of unstructured data, object detection and anomaly detection by image recognition, and work status grasping by video analysis is automatically executed on the integrated data. For example, unification of inventory data managed in different units, real-time stream integration of IoT sensor data, keyword extraction of worker memos, anomaly detection of surveillance camera videos, and the like are performed. Specifically, the present system activates a data pipeline engine operating on a distributed processing framework. The present system acquires, as input data, the multidimensional data frame generated in Step 1 and a high-resolution video stream of thirty frames per second acquired from a surveillance camera. The present system applies a Z-score normalization algorithm to numerical data, and scales a mean to zero and a standard deviation to one. The present system executes a one-hot encoding process on categorical data, and converts it into a sparse binary vector. The present system applies a three-dimensional convolutional neural network to the video stream. The present three-dimensional convolutional neural network simultaneously extracts spatial features and temporal features. The present system generates, as output data, a time-series tensor indicating skeletal coordinates of a worker in a video and a score vector indicating an occurrence probability of a specific dangerous behavior. The present system executes morphological analysis and named entity extraction from a daily report text of a worker using a natural language processing model. The present system maps the extracted keywords to a word embedding vector space, and expresses semantic features of the text as a numerical tensor. The present system applies an irreversible anonymization process using a hash function or a format-preserving encryption process to a data column including personal information. The present system combines these preprocessed data, and constructs a feature amount matrix optimized for an input of a machine learning model. Thereby, the present system converts dirty data in a real world including noise and missing data into a pure tensor space capable of being processed by a mathematical algorithm. The present system exhibits a technical effect of accelerating a convergence speed of a subsequent artificial intelligence model and maximizing inference accuracy. The present technology is extremely important in application fields such as multimodal sensor fusion processing for autonomous driving and transaction data cleansing for money laundering detection in a financial institution.

Step 3: Future Prediction, Optimization, and Anomaly Detection by Generative AI The preprocessed data is input to the generative AI, and demand prediction, inventory optimization, delivery plan optimization, worker allocation optimization, equipment operation prediction, anomaly detection, risk scenario analysis, field improvement proposal, educational scenario generation, and the like are executed in real time and automatically by combining a machine learning algorithm, a deep learning model, a natural language processing model, a reinforcement learning model, an anomaly detection model, a clustering model, an optimization algorithm, and the like. For example, future shipping demand is predicted by a time-series prediction model using LSTM or Transformer, and a sudden demand increase risk or a stockout risk is detected in advance. Specific examples of prompt sentences to be read by the generative AI include “Predict shipping demand for the next 14 days with high accuracy based on shipping performance, inventory amount, weather, traffic, and event information for the past two years, and if there is a sudden demand increase risk, output its factors and countermeasures together”, “Automatically generate the number of workers required during a large sale period next week and an optimal shift allocation plan in consideration of past work history and shipping performance”, “Predict an equipment operation rate and a failure risk for the next one week based on an equipment operation history and a maintenance record, and propose a necessary maintenance plan”, “Output an anomaly detection alert and a recommended countermeasure when a shipping volume exceeds twice a normal volume”, “Simulate a delivery delay risk and an alternative delivery route plan when a typhoon approaches”, and the like. Specifically, the present system synchronously executes a plurality of artificial intelligence models on a parallel computing cluster using a graphics processing unit. The present system acquires, as input data, the feature amount matrix constructed in Step 2 and a dynamically generated natural language prompt character string. The present system uses a hybrid model combining a long short-term memory network and a self-attention mechanism for time-series prediction. The present hybrid model assigns a high weight to a sudden fluctuation at the time of occurrence of a specific event while maintaining long-term dependency of a past time-series pattern. The present system generates, as output data, a continuous value tensor indicating a future demand amount of each product and a variance matrix indicating uncertainty of prediction. The present system inserts the prediction result into a context window of a large language model. The present large language model adopts a transformer architecture having billions of parameters. The present large language model generates structured text data including an analysis result of a risk factor and a specific response procedure based on the input prompt and numerical data. The present system executes a particle swarm optimization method as an optimization algorithm. The present system defines a combination of delivery routes as particles on a multidimensional search space. The present system iteratively updates a position and a velocity of each particle, and searches for an optimal solution that minimizes a total delivery cost. The present system uses an autoencoder model for anomaly detection. The present autoencoder model reconstructs a tensor of input sensor data, and outputs an anomaly flag when a reconstruction error exceeds a statistical threshold. Thereby, the present system completes not only simple numerical prediction but also logical inference based on a prediction result and formulation of a specific action plan inside a computer. The present system exhibits a technical effect of enabling objective and highly accurate decision-making excluding human cognitive bias. The present technology provides extremely high value in application fields such as an autonomous control system of a complex supply chain and a predictive maintenance and automatic operation system of a large-scale plant.

Step 4: Automatic Generation and Presentation of Decision-Making Plan Based on a future prediction result and a scenario simulation result by the generative AI processing unit, decision-making plans such as a resource allocation plan, a worker shift plan, an equipment operation plan, a delivery route plan, a countermeasure at the time of anomaly occurrence, a risk avoidance measure, a cost reduction plan, a service quality improvement plan, a KPI achievement degree prediction, a field improvement proposal, an emergency response manual generation, and an educational scenario generation are automatically generated, and presented to a field staff member and a manager in real time through the user interface unit. For example, an additional order and a review of a delivery plan are proposed at the time of a sudden increase in demand, experienced workers are intensively allocated in a busy time zone in worker allocation, maintenance is planned ahead of schedule in a high operation period in an equipment operation plan, and an optimal route avoiding congestion and regulation is proposed in a delivery route plan. Specifically, the present system inputs a wide variety of prediction tensors and text data output from the generative artificial intelligence processing unit to an integrated inference engine. The present integrated inference engine maps a causal relationship between each prediction result using a knowledge graph. The present system acquires, as input data, a demand prediction tensor, an equipment failure probability vector, and a personnel shortage risk score. The present system passes these input data to a multi-objective optimization solver. The present multi-objective optimization solver generates a plurality of solution candidates simultaneously satisfying conflicting objective functions of cost minimization and service level maximization based on a concept of Pareto optimality. The present system generates, as output data, a structured decision-making package including a specific action list corresponding to each solution candidate, a numerical value of an expected return on investment, and a resource requirement necessary for execution. The present system transmits the decision-making package to a rendering engine of the user interface unit. The present rendering engine analyzes the received data and constructs a dynamic dashboard screen. The present system draws the proposed delivery route plan as a vector layer on a geographic information system. The present system visualizes the worker shift plan as an interactive Gantt chart. The present system expands the emergency response manual as a step-by-step wizard format user interface component. The present system attaches basis data indicating why the plan is recommended to each decision-making plan as a tooltip or a drill-downable graph. Thereby, the present system converts a result of a complex mathematical operation into a format that a human can intuitively understand and immediately put into action. The present system exhibits a technical effect of eliminating a bottleneck of an interface between a human and a computer in a decision-making process. The present technology is extremely effective in application fields such as a tactical command and control system in a military operation and an information integrated display system for an emergency response headquarters at the time of a large-scale disaster.

Step 5: Decision-making and feedback acquisition by a user The user operates a dashboard, a report, a scenario setting screen, a decision-making plan presentation screen, a feedback input screen, a notification receiving screen, a history reference screen, a report output screen, an alert receiving screen, a KPI monitoring screen, a field improvement proposal screen, an education scenario browsing screen, and the like to perform adoption/correction/rejection of a decision-making plan, change of a scenario condition, input of feedback, and the like. A field staff member confirms a demand prediction and an inventory optimization plan, a manager overviews an overall resource allocation status and a risk scenario, and a field education staff member browses an education scenario and a training material generated by AI to utilize them for field education. Specifically, the present system asynchronously captures a user operation event via a user interface unit. The present system acquires, as input data, an identifier of the decision-making plan selected by the user, a numerical vector of a parameter changed by a slider operation, and a natural language comment character string input to a text box. When the user corrects the decision-making plan, the present system calculates a difference vector between an original proposed value and a corrected value. The present system extracts the difference vector as a feature amount indicating an implicit preference of the user. The present system generates, as output data, a feedback payload including a user operation content, a time stamp of an operation date and time, and a user identifier. The present system transmits the feedback payload to a back-end server via an application programming interface. When the user changes the scenario condition, the present system immediately feeds back the changed parameter to a simulation engine. The simulation engine executes a recalculation process in milliseconds using a cache on an in-memory database. The present system push-distributes the recalculated result to a client terminal via WebSocket communication, and dynamically updates a screen display. The present system collects a scroll position, a stay time, and a click history when the education staff member browses the training material as heat map data. Thereby, the present system establishes a closed-loop control that takes human expertise and intuition into the system as quantitative data. The present system exerts a technical effect of evolving a static system into a dynamic learning system that grows with user utilization. The present technology is an indispensable mechanism in application fields such as doctor's diagnosis feedback collection in a medical diagnosis support system and student's comprehension level tracking in a personalized learning support system.

Step 6: Reflection of feedback to generative AI and self-learning Feedback from a user, performance data, external environment change data, response history at the time of system failure occurrence, judgment tendency of a field staff member, past decision-making results, and the like are automatically reflected in generative AI, parameters and a structure of a model are automatically optimized, and prediction accuracy and an optimization algorithm are continuously improved. For example, when a divergence between an actual demand and a predicted value is large, a cause analysis is automatically executed, and re-learning of the model and addition/deletion of a feature amount are automatically performed. Specific examples of a prompt sentence to be read by the generative AI include “When a divergence between a demand prediction and a performance value for the latest three months is large, analyze a factor thereof and automatically execute re-learning of a model and review of a feature amount”, “Optimize a parameter of a decision-making plan generation algorithm based on a feedback content from a user, and reflect it at the time of next proposal”, and the like. Specifically, the present system periodically activates an automated machine learning pipeline as a background process. The present system acquires, as input data, a set of feedback payloads collected in Step 5, a past prediction tensor, and a performance tensor indicating an actual observation value. The present system calculates a mean absolute error and a root mean square error between the prediction tensor and the performance tensor. When the error exceeds a preset allowable threshold, the present system fires a drift detection alert of the model. When the drift is detected, the present system executes a feature amount importance analysis algorithm to specify an input variable that is a main cause of a prediction error. The present system generates, as output data, a search vector in a hyperparameter space indicating a new combination of feature amounts. The present system automatically tunes a hyperparameter of the model based on the search vector using a Bayesian optimization method. The present system inputs a feedback text in a natural language from the user to a large language model. The large language model extracts a user's intention and a new constraint condition from the text, and dynamically rewrites a reward function of a reinforcement learning agent. The present system executes a proximal policy optimization algorithm using the updated reward function to fine-tune a weight of a neural network of a decision-making policy. The present system operates the re-learned new model and the existing model in parallel in a shadow deployment environment. The present system comparatively evaluates performances of both by a statistical hypothesis test. The present system seamlessly hot-swaps the model in a production environment only when superiority of the new model is proved. Thereby, the present system completely prevents deterioration of the model against secular change of an environment and an unknown event. The present system exerts a technical effect of realizing an autonomous evolution mechanism in which the system itself continuously improves performance without human intervention. The present technology exhibits an extremely high effect in application fields such as an automatic update system of an algorithmic trading model in a financial market and a self-adaptive system of an unknown malware detection engine in cybersecurity.

### Specific Use Case

For example, when the system of the present invention is used in a logistics center, a data integration unit collects, as shipping performance data, a shipping volume by day and time zone, an inventory amount by product, a shipping volume by delivery destination, a delivery delay history, a return history, a shipping pattern in a busy season and an off-season, a loading rate for each delivery vehicle, and the like, further collects, as weather data, rainfall, temperature, typhoon information, snowfall information, and weather warnings, as traffic data, a congestion index of a main road, accident occurrence information, traffic regulation information, road construction information, and a required time for each delivery route, as worker operation data, a shift table, an attendance record, a work history for each worker, skill information, a vacation schedule, and a workload history, as equipment operation history data, an operation history, a maintenance record, a failure history, an operation rate, and a consumable part replacement history of a forklift and an automated guided vehicle, as external event data, a large-scale sale, a holiday, a disaster, a regulation change, and social event information, and as IoT sensor data, a temperature/humidity sensor value, a vibration sensor value, a package weight sensor value, an entrance/exit management sensor value, and the like by various means, and centrally integrates them based on time-series information, attribute information, and ID information. The data integration unit automatically executes preprocessing such as missing data complementation, anomaly detection, standardization of units and scales, deduplication, data type conversion, data reliability evaluation, anonymization and masking, encryption, structured conversion of unstructured data, object detection and anomaly detection by image recognition, and work status grasping by video analysis on these data. Specifically, the present system captures streaming data of millions of points per second in parallel via an edge computing network stretched around the logistics center. The present system acquires, as input data, a three-dimensional point cloud data tensor from a LiDAR sensor mounted on the automated guided vehicle, and a radio wave intensity vector from a radio frequency identification tag attached to each pallet. The present system acquires multidimensional array data indicating a precipitation probability and a wind speed in units of a one-kilometer mesh from an external weather information provider via an application programming interface. The present system integrates these structured data and unstructured data into a single data lake using a distributed streaming platform. The present system activates an in-memory distributed processing engine in the data lake. The present system applies voxel grid filtering to the three-dimensional point cloud data to retain spatial features while reducing a data amount. The present system applies a Kalman filter to the radio wave intensity vector to remove noise due to multipath interference and estimate accurate position coordinates of the pallet. The present system generates, as output data, a huge feature amount matrix in which all sensor data, weather data, and business data are mapped on the same timeline. The present system executes a statistical complementation process using a multiple imputation method on a missing value in the feature amount matrix. The present system calculates a Mahalanobis distance for anomaly detection, and automatically masks an outlier in a multidimensional space. Thereby, the present system constructs a complete digital twin of a physical logistics center in a cyber space in real time. The present system exerts a technical effect of providing extremely high-quality learning data without noise to a subsequent artificial intelligence model. The present technology is an indispensable fundamental technology in application fields such as a control system of a fully automated unmanned warehouse and a supply chain control tower that integrally manages a plurality of manufacturing bases distributed over a wide area.

A generative AI processing unit predicts a future shipping demand using a time-series prediction model such as LSTM or Transformer with the integrated and preprocessed data as input, detects a demand surge risk and a stockout risk in advance, calculates an optimal inventory amount in consideration of a demand prediction result, an inventory turnover rate, a storage space constraint, an ordering lead time, an ordering cost, an inventory storage cost, a stockout penalty cost, and the like, and prevents excess inventory and stockout. In a delivery plan, an optimal delivery route and schedule are automatically generated in consideration of a shipping volume prediction, a traffic condition, the number of vehicles, road regulation information, a delivery cost, a delivery priority, and the like. In worker allocation, an optimal allocation plan is generated by clustering or an optimization algorithm based on a shipping volume, an inventory fluctuation, a worker skill, a shift request, a health condition, qualification information, and the like, and a labor cost and work efficiency are made compatible. In equipment operation prediction, an operation rate and a failure risk are predicted based on an equipment operation history, a maintenance record, a consumable part life prediction, an anomaly detection history, and the like, and maintenance and spare machine arrangement are proposed. In anomaly detection, when a shipping volume, an equipment operation rate, a worker workload, an inventory amount, a delivery delay, an energy consumption amount, IoT sensor data, or the like deviates from a threshold, an alert is issued and notified to a field staff member and a manager. In risk scenario analysis, a plurality of scenarios such as a delivery delay at the time of typhoon approach, an additional personnel requirement amount at the time of a large-scale sale, an alternative route at the time of traffic regulation, a recovery plan at the time of simultaneous equipment failure, a countermeasure at the time of demand surge due to a social event, and a cost impact at the time of new regulation introduction are simulated, and an optimal countermeasure and resource allocation plan are automatically generated. In a field improvement proposal, a past work history and an error occurrence pattern are analyzed, and a work procedure review and an equipment layout optimization plan are generated. In education scenario generation, an education scenario and a training material conforming to an actual situation of a field are automatically generated. Specifically, the generative artificial intelligence processing unit executes an integrated inference pipeline that orchestrates a plurality of specialized neural networks. The generative artificial intelligence processing unit acquires, as input data, the feature amount matrix generated in the preceding stage and a time-series tensor indicating a sales performance of each product for the past 3,000 days. The generative artificial intelligence processing unit inputs the time-series tensor to a multi-layer transformer encoder, and extracts a co-occurrence relationship and a seasonal fluctuation pattern between products using a self-attention mechanism. The generative artificial intelligence processing unit generates, as output data, a multidimensional array indicating a predicted demand amount by day and by product for the next 30 days, and a probability distribution tensor indicating a confidence interval of each predicted value. The generative artificial intelligence processing unit inputs the prediction result to a solver of mixed integer linear programming. The solver sets a volume constraint of a warehouse, an ordering lot size, and a lead time as constraint conditions, and calculates an optimal ordering schedule matrix that minimizes a total logistics cost. The generative artificial intelligence processing unit uses a graph convolutional network in optimization of a delivery plan. The generative artificial intelligence processing unit expresses a road network as a graph structure of nodes and edges, and assigns a real-time congestion index to each edge as a weight. The generative artificial intelligence processing unit solves a capacitated vehicle routing problem, which is an extended version of a traveling salesperson problem, using a deep reinforcement learning agent, and outputs a sequence vector of an optimal delivery route. The generative artificial intelligence processing unit combines a survival time analysis model using a Weibull distribution and a recurrent neural network in equipment operation prediction. The generative artificial intelligence processing unit receives a vibration frequency spectrum of a motor as an input, and outputs a probability that a specific bearing will fail within the next 100 hours as a percentage. The generative artificial intelligence processing unit converts these numerical prediction results into a natural language report using a large language model. Thereby, the present system instantaneously derives a mathematically proven optimal solution from astronomical combinations that cannot be processed by human rules of thumb. The present system exerts a technical effect of simultaneously achieving inventory reduction, delivery cost reduction, and equipment operation rate improvement. The present technology brings an extremely high competitive advantage in application fields such as a fulfillment center supporting an on-demand same-day delivery service and a parts supply network of a huge factory adopting a just-in-time production system.

A decision-making support unit automatically generates decision-making plans such as a resource allocation plan, a worker shift plan, an equipment operation plan, a delivery route plan, a countermeasure at the time of anomaly occurrence, a risk avoidance measure, a cost reduction plan, a service quality improvement plan, a KPI achievement degree prediction, a field improvement proposal, an emergency response manual generation, and an education scenario generation based on a future prediction result and a scenario simulation result by a generative AI processing unit, and presents them to a field staff member and a manager in real time through a user interface unit. The field staff member can confirm a demand prediction and an inventory optimization plan, change a scenario condition, and input feedback to the decision-making plan, and the manager can overview an overall resource allocation status and a risk scenario, and perform adoption/correction/rejection of the decision-making plan, change of the scenario condition, input of feedback, and the like. A field education staff member can browse an education scenario and a training material generated by AI and utilize them for field education. Specifically, the decision-making support unit receives a multidimensional optimal solution matrix and a probability distribution tensor output from the generative artificial intelligence processing unit. The decision-making support unit maps these mathematical output values to specific business actions using a rule-based expert system. The decision-making support unit acquires, as input data, current allocation coordinates of each worker, a biometric sensor score indicating a fatigue degree, and a numerical vector indicating a scheduled completion time of each task. The decision-making support unit inputs these input data to a dynamic task allocation algorithm. The decision-making support unit generates, as output data, a structured task object including an instruction content of a task to be executed next, a movement route, and a target completion time for each worker. The decision-making support unit transmits the task object to a drawing engine of the user interface unit. The user interface unit superimposes and displays a virtual marker indicating a position of a shelf to be picked and a navigation arrow of a shortest movement route within a field of view of smart glasses worn by the worker using augmented reality technology. The decision-making support unit renders a three-dimensional heat map indicating an operation status of the entire logistics center to a terminal of the manager. When the manager taps a specific area on the heat map, the decision-making support unit dynamically generates a drill-down chart indicating a bottleneck factor of the area. The decision-making support unit directly transmits a control command to a group control server of automated guided robots triggered by an operation event in which the manager presses an approval button. The decision-making support unit automatically generates an interactive multimedia material in which video data of a past picking mistake case and a text of an improvement point generated by a large language model are synchronized for the education staff member. Thereby, the present system seamlessly transmits an inference result of advanced artificial intelligence in a format optimized for a role of each user from a field worker to a management layer. The present system exerts a technical effect of bringing a time lag from decision-making to action execution close to zero. The present system physically prevents a human error. The present technology is extremely effective in application fields such as a huge international logistics hub where multilingual and multinational workers are mixed, and a material management system of a space station where work under an extreme environment is required.

Specific examples of a prompt sentence to be read by generative AI include “Predict a shipping demand for the next 14 days with high accuracy based on a shipping performance, an inventory amount, weather, traffic, and event information for the past two years, and if there is a demand surge risk, output a factor thereof and a countermeasure together”, “Automatically generate the number of workers required during a large-scale sale period next week and an optimal shift allocation plan in consideration of a past work history and a shipping performance”, “Predict an equipment operation rate and a failure risk for the next one week based on an equipment operation history and a maintenance record, and propose a necessary maintenance plan”, “Output an anomaly detection alert and a recommended countermeasure when a shipping volume exceeds twice a normal volume”, “Simulate a delivery delay risk and an alternative delivery route plan at the time of typhoon approach”, “When a divergence between a demand prediction and a performance value for the latest three months is large, analyze a factor thereof and automatically execute re-learning of a model and review of a feature amount”, “Optimize a parameter of a decision-making plan generation algorithm based on a feedback content from a user, and reflect it at the time of next proposal”, and the like. Specifically, the present system includes a prompt generation unit. The prompt generation unit converts structured data acquired from a database into a natural language text and a numerical tensor. The prompt generation unit constructs the converted data as input data to a large language model. The present system generates a multidimensional time-series array as input data. The number of dimensions of the input data is, for example, a two-dimensional tensor having 730 time steps and 50 feature amount dimensions. Element contents of the input data include a past shipping volume vector, a categorical variable of weather, and a binary flag of presence/absence of an event. The present system executes zero-averaging and variance normalization of numerical data as preprocessing. The present system executes one-hot encoding of categorical data as preprocessing. As a specific example of the input data, the present system generates a daily shipping volume array for the past 7 days, an array of precipitation millimeter values, and an array of sale holding flags. The present system embeds these numerical tensors into a text prompt. The present system combines numerical data and text data using a special token in an embedding process. The present system supplies the combined data to an input layer of the large language model. The large language model adopts a transformer architecture. The large language model calculates a dependency relationship between each element in the input data using a self-attention mechanism. The large language model executes weighting of a feature amount in a high-dimensional space. The large language model generates a probability distribution and a structured text as output data. A format of the output data includes a numerical score indicating a demand amount of each prediction day, a floating-point number indicating an anomaly occurrence probability, and a text character string describing a countermeasure. As a specific example of an output value, the large language model outputs 0.85 as a demand prediction score. The large language model outputs 1 as an anomaly detection flag. The large language model outputs a personnel increase instruction text as a recommended countermeasure. The present system transfers an output result to a subsequent processing module. The present system executes a threshold determination process as a subsequent process. The present system executes a branch process when the anomaly occurrence probability exceeds a predetermined threshold. The present system activates an alert generation module in the branch process. The present system parses the output countermeasure text. The present system automatically generates an update query of a shift management database using the parsed data. The present system executes the generated query to update the database. The present system automatically triggers a re-learning process of the model. The present system calculates a mean square error between a predicted value and a performance value. The present system updates a weight parameter of the model using an error backpropagation method when the mean square error exceeds an allowable range. The present system uses an optimization algorithm that dynamically adjusts a learning rate. The present system executes reinforcement learning using feedback from a user as a reward signal. The present system optimizes a parameter of a decision-making plan generation algorithm using a policy gradient method. By these processes, the present system realizes objective data-driven inference that does not depend on human intuition. The present system analyzes a complex correlation of high-dimensional data. The present system achieves highly accurate future prediction that is impossible by conventional rule-based processing. The present system dynamically optimizes allocation of computing resources. The present system reduces unnecessary calculation to improve a processing speed. The present system exhibits technical effects of reduction of an operation cost and dramatic improvement of business efficiency in a specific use case of optimization of personnel allocation and inventory management in a logistics center.

As described above, the system of the present invention centrally and automatically realizes data integration, future prediction, optimization, anomaly detection, risk analysis, field improvement, and education support by AI in field operation of a logistics center, and provides an advanced foundation for a field staff member and a manager to make a prompt and optimal decision-making. Specifically, the present system operates on a distributed computing environment in which a plurality of computing nodes are connected via a network. The present system distributedly arranges a data integration unit, a prediction inference unit, and an optimization control unit in each computing node. The present system maps input data of heterogeneous formats to a common vector space in the data integration unit. The present system executes a deep neural network in the prediction inference unit. The prediction inference unit receives a multidimensional feature amount tensor as input data. The number of dimensions of the input data is, for example, a three-dimensional tensor having 100 sensor nodes and a sampling frequency of 10 Hz. Element contents of the input data include vibration data of a conveyor, temperature data, and current value data of a motor. The present system executes a fast Fourier transform as preprocessing to extract a feature amount in a frequency domain. As a specific example of the input data, the present system generates an amplitude spectrum array of a specific frequency band, a peak frequency value, and a numerical value of a signal-to-noise ratio. The prediction inference unit extracts a spatial feature using a convolutional neural network. The prediction inference unit learns a temporal dependency relationship using a long short-term memory network. The prediction inference unit outputs continuous values of an anomaly score and an equipment failure probability as output data. A format of the output data is an array of floating-point numbers normalized in a range of 0 to 1. As a specific example of an output value, the prediction inference unit outputs 0.92 as a motor anomaly score. The prediction inference unit outputs 48 hours as a failure prediction time. The prediction inference unit outputs a gradient class activation map indicating a contribution degree of an anomaly factor. The present system transmits an output result to the optimization control unit. The optimization control unit executes a reinforcement learning agent as a subsequent process. The optimization control unit receives the anomaly score as an input of a state space. The optimization control unit defines an operation speed adjustment and a stop command of equipment as an action space. The optimization control unit sets minimization of downtime and maximization of throughput as a reward function. The optimization control unit updates an optimal action value function using a Q-learning algorithm. The present system generates a control signal based on the determined optimal action. The present system transmits the control signal to a programmable logic controller to directly control physical equipment. The present system executes a Monte Carlo simulation in a risk analysis process. The present system calculates a large number of scenarios based on a probability distribution in parallel. The present system aggregates calculation results to calculate an expected value of a risk. The present system executes a clustering algorithm in a field improvement process. The present system classifies flow line data of a worker using a K-means method. The present system automatically extracts an inefficient flow line pattern. The present system utilizes generative AI in an education support process. The present system calculates a difference between the extracted inefficient pattern and a pattern of a skilled worker. The present system automatically generates an individual improvement instruction text based on difference data. By cooperative operation of these hardware and software, the present system minimizes latency of data processing. The present system reduces a communication load between an edge device and a cloud server. The present system simultaneously processes a huge number of variables exceeding human cognitive limits. The present system enables adaptive control in milliseconds against a dynamic environment change of a logistics center. The present system brings about a clear technical improvement of autonomous optimization of a computer system itself and sophistication of resource management, not limited to mere business efficiency improvement.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

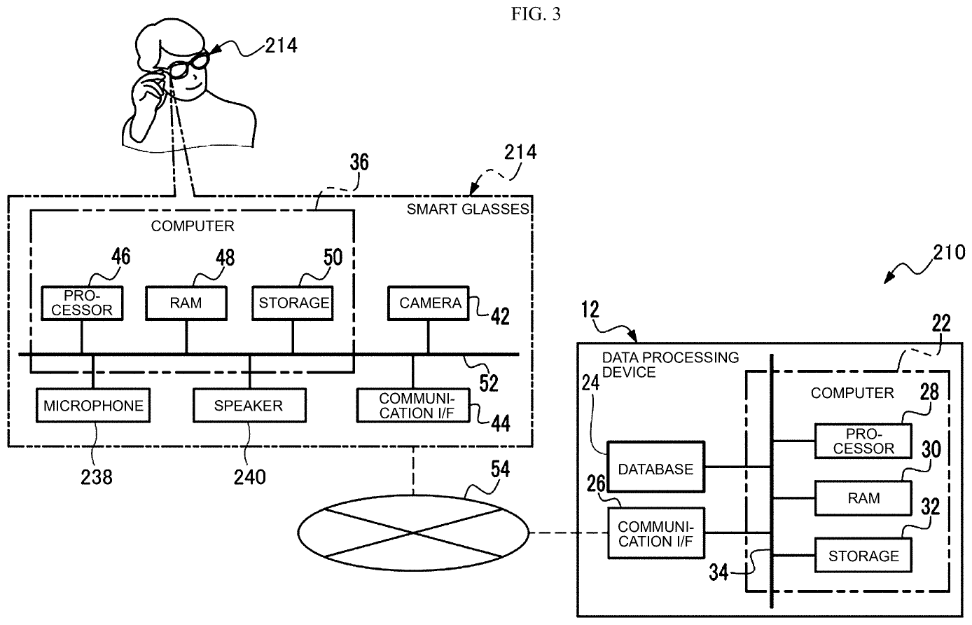

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

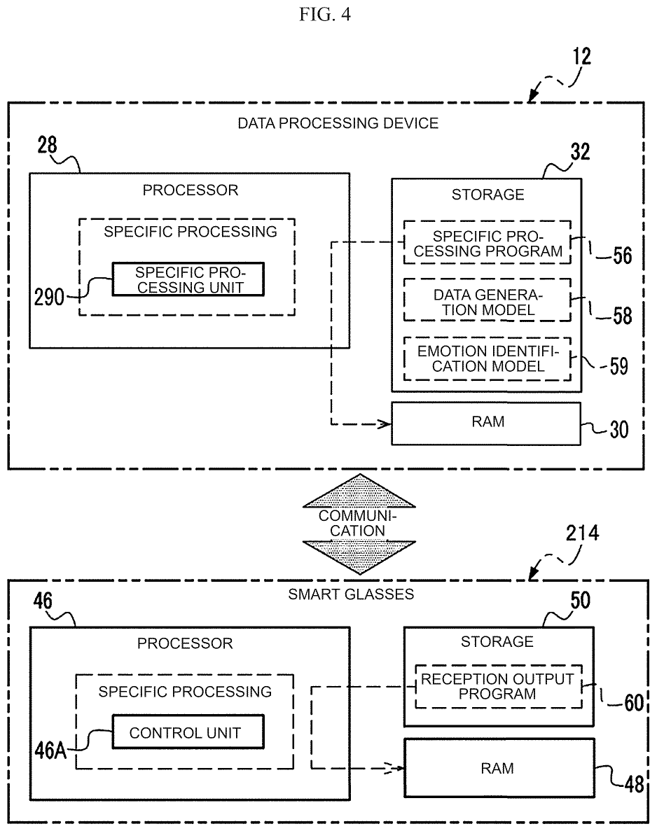

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

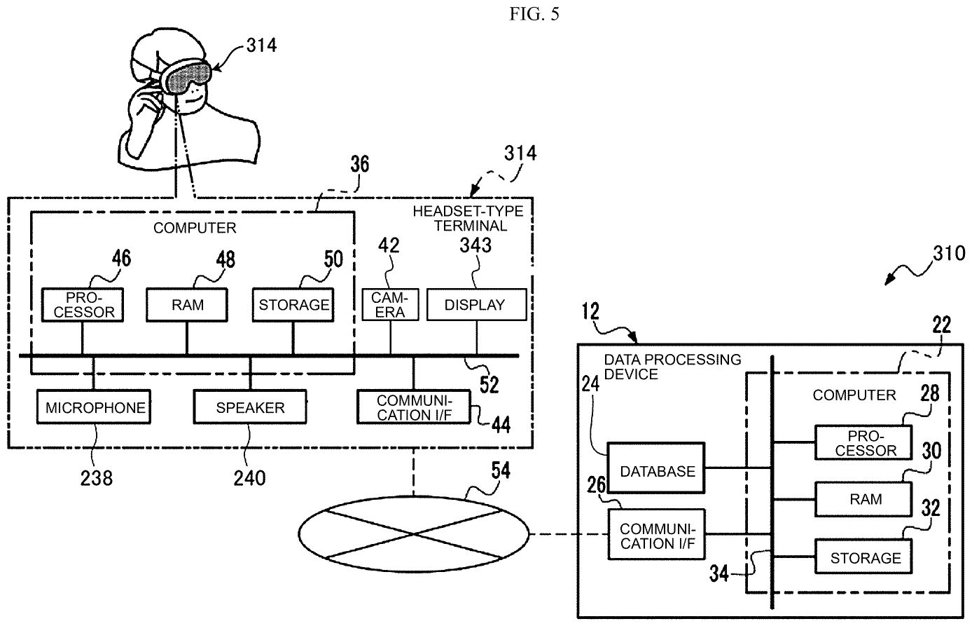

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

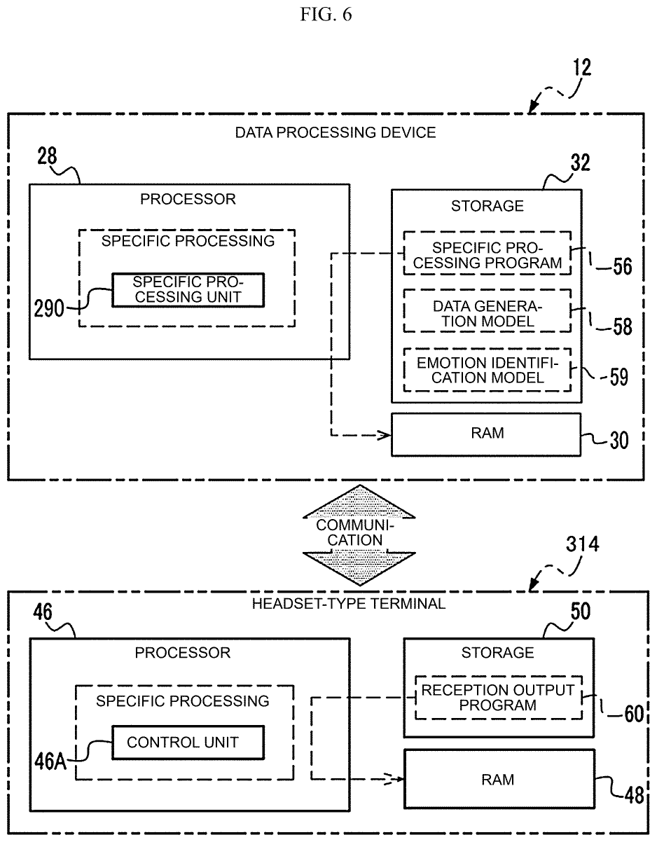

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

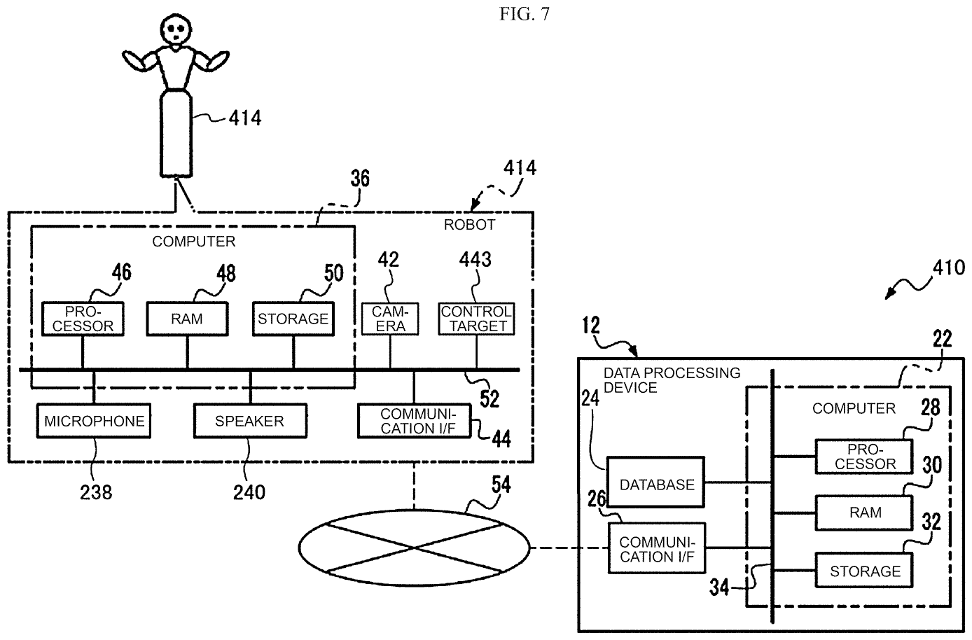

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

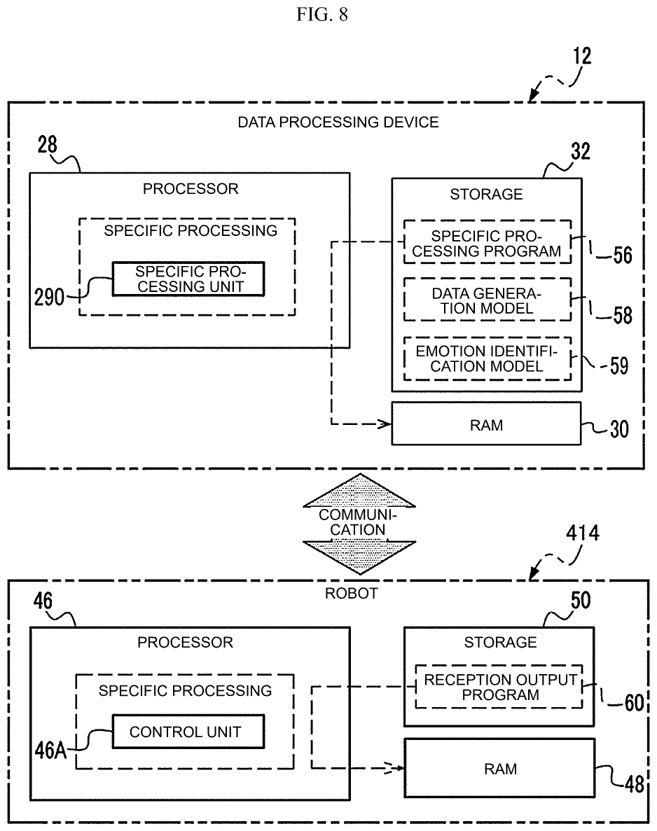

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

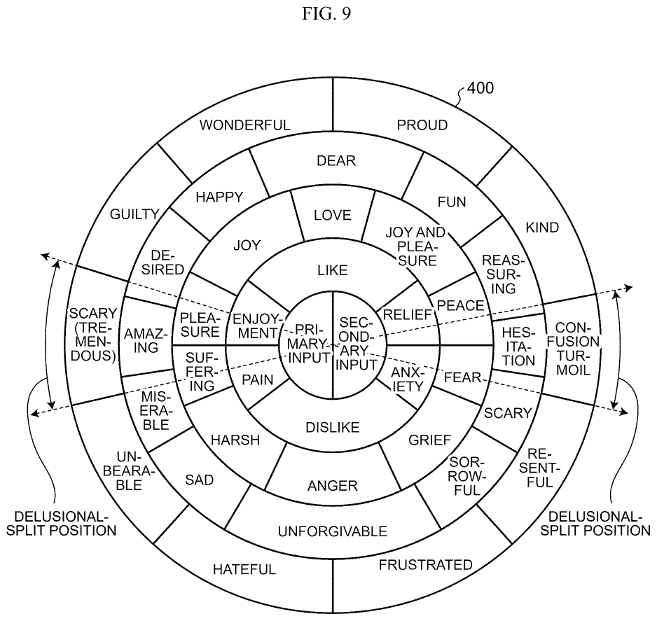

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

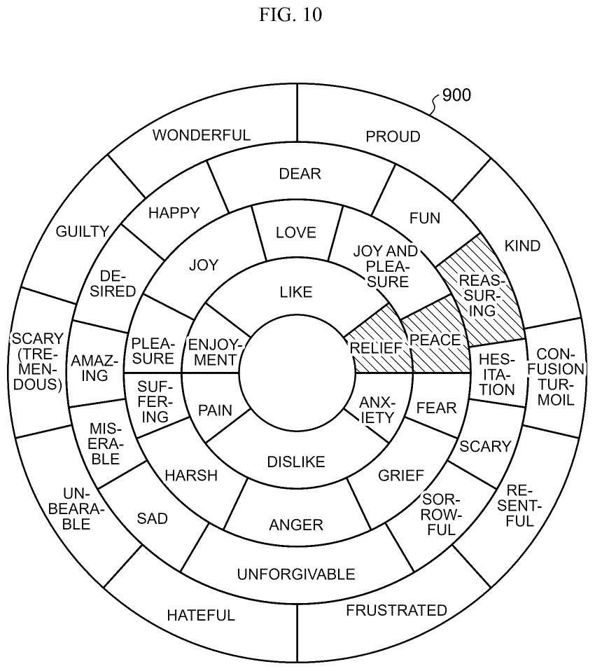

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A logistics center optimization system comprising: a data integration unit; a generative AI processing unit; and a decision-making support unit, wherein the data integration unit centrally collects and integrates a wide variety of data, such as shipping performance data inside and outside a logistics center, inventory data, receipt and shipment history data, delivery destination information, weather data, traffic data, worker operation data, equipment operation history data, external event data, shift tables, maintenance records, and IoT sensor data, based on time-series information and attribute information by means of API linkage, file transfer, database connection, IoT device linkage, external data provider linkage, and the like, and automatically executes preprocessing such as missing data complementation, anomaly detection, unit unification, data type conversion, deduplication, structured conversion of unstructured data, data reliability evaluation, and anonymization and encryption; the generative AI processing unit executes demand prediction, inventory optimization, delivery plan optimization, worker allocation optimization, equipment operation prediction, anomaly detection, risk scenario analysis, and the like in real time and automatically by combining a machine learning algorithm, a deep learning model, a natural language processing model, a reinforcement learning model, and the like with the integrated and preprocessed data as input, and further executes scenario simulation under a plurality of hypothetical conditions set by a user and model optimization by self-learning; the decision-making support unit automatically generates decision-making plans such as a resource allocation plan, a worker shift plan, an equipment operation plan, a delivery route plan, a countermeasure at the time of anomaly occurrence, and a risk avoidance measure based on a future prediction result and a scenario simulation result by the generative AI processing unit, presents the decision-making plans to a field staff member and a manager in real time through a user interface, and feeds back feedback and performance data from the user to the generative AI processing unit again to continuously evolve model accuracy and an optimization algorithm; and all of these processes are operated using generative AI.

### Supplementary Note 2

The system according to Supplementary Note 1, wherein the generative AI processing unit inputs a plurality of risk scenarios, such as a sudden increase in shipping volume in a logistics center, weather deterioration, traffic regulation, external event occurrence, equipment failure, and worker shortage, as hypothetical conditions, and automatically generates a demand prediction, an inventory fluctuation, a delivery delay risk, a worker allocation plan, an equipment operation plan, a risk avoidance measure, and the like under each of the scenarios, and the decision-making support unit comparatively analyzes prediction results and optimization plans for each of these scenarios, presents an optimal decision-making plan to a user, and reflects a selection and feedback of the user to the generative AI processing unit, thereby continuously realizing an accuracy improvement of the model and an optimization of decision-making.

### Supplementary Note 3

The system according to Supplementary Note 1, wherein the decision-making support unit automatically generates a specific execution plan such as an optimal resource allocation plan, a worker shift plan, an equipment maintenance plan, a delivery route optimization plan, an emergency countermeasure at the time of anomaly occurrence, a cost reduction plan, and a service quality improvement plan based on a future prediction result and a scenario simulation result by the generative AI processing unit, in consideration of an inventory amount, the number of workers, an equipment operation rate, the number of delivery vehicles, constraint conditions of various resources, external environment changes, and the like in a logistics center, presents the specific execution plan to a field staff member and a manager through a user interface, and feeds back feedback and performance data from a user to the generative AI processing unit, thereby continuously realizing self-learning of a model and optimization of a decision-making plan.

What is claimed is:

1. A system comprising:
circuitry configured to:
receive, via a communication interface coupled to a packet-switched network, heterogeneous data streams from a plurality of data source endpoints, and store the heterogeneous data streams in a storage device;
apply preprocessing operations comprising missing value imputation, standardization, normalization, and deduplication to the heterogeneous data streams, and integrate the preprocessed data into a unified time-series tensor structure indexed by time-series information and attribute identifiers;
apply a deep learning model to the unified time-series tensor to generate prediction vectors comprising future state probability distributions across a plurality of forecast dimensions, and generate scenario simulation outputs by applying the deep learning model to the unified time-series tensor conditioned on a plurality of hypothetical condition parameter sets;
generate decision support data records by applying a generative neural network model to the prediction vectors and the scenario simulation outputs, the decision support data records comprising ranked strategy sequences with associated resource allocation parameters; and
transmit the decision support data records to terminal devices via the communication interface.

2. The system according to claim 1, wherein the circuitry is configured to receive the heterogeneous data streams via a load balancer that distributes incoming data traffic across a plurality of computing nodes, process each data stream on an assigned computing node as an independent containerized microservice, and store processed data in a centralized storage device accessible to all computing nodes.

3. The system according to claim 2, wherein the circuitry is configured to establish an encrypted communication channel between each computing node and the storage device using a secure socket layer protocol, and apply a data exchange protocol between containerized microservices using a message queue to ensure ordered processing of data stream records.

4. The system according to claim 1, wherein the circuitry is configured to apply a missing value imputation algorithm to time-series data records having null or missing values by computing interpolated values from surrounding non-null records using a polynomial interpolation function, and apply a standardization transform to continuous numerical data fields to produce zero-mean unit-variance normalized values.

5. The system according to claim 1, wherein the circuitry is configured to apply a transformer-based time-series model to the unified time-series tensor to compute multi-step ahead prediction vectors, the transformer-based time-series model comprising a self-attention mechanism operating over the time axis of the unified time-series tensor to capture long-range temporal dependencies.

6. The system according to claim 5, wherein the circuitry is configured to compute a prediction confidence interval for each prediction vector dimension by applying a Monte Carlo dropout sampling procedure to the transformer-based time-series model over a plurality of forward passes, and incorporate the prediction confidence intervals as uncertainty parameters in the decision support data records.

7. The system according to claim 1, wherein the circuitry is configured to generate scenario simulation outputs for each hypothetical condition parameter set by modifying specified dimensions of the unified time-series tensor according to the hypothetical condition parameters and applying the deep learning model to the modified tensor, and store each scenario simulation output with its corresponding hypothetical condition parameter set identifier in the storage device.

8. The system according to claim 7, wherein the circuitry is configured to apply the generative neural network model to a plurality of scenario simulation outputs to generate comparative analysis data comprising ranked scenario identifiers ordered by an aggregate outcome score, and incorporate the comparative analysis data in the decision support data records as a scenario comparison section.

9. The system according to claim 1, wherein the circuitry is configured to apply a graph neural network to a supply chain relationship graph constructed from attribute identifiers in the unified time-series tensor, the supply chain relationship graph comprising entity nodes and directed dependency edges, and execute message passing operations to generate connectivity feature vectors representing inter-entity dependency relationships for incorporation in the prediction vector computation.

10. The system according to claim 9, wherein the circuitry is configured to detect anomalous connectivity patterns in the supply chain relationship graph by comparing current edge weight values against historical baseline edge weight distributions, generate a disruption risk signal when an anomalous connectivity pattern exceeds a disruption threshold parameter, and incorporate the disruption risk signal as an additional input feature in the generative neural network model during decision support data record generation.

11. The system according to claim 1, wherein the circuitry is configured to apply a self-learning update procedure to the deep learning model at configurable intervals by extracting new training examples from recently received heterogeneous data streams and corresponding validated outcome records, and fine-tuning the deep learning model on the new training examples to reduce prediction error on the most recent time window.

12. The system according to claim 1, wherein the circuitry is configured to generate a risk evaluation score for each ranked strategy sequence in the decision support data records by applying the generative neural network model to the corresponding resource allocation parameters and historical outcome records associated with similar strategy sequences retrieved from a vector database, and attach the risk evaluation score to each ranked strategy sequence.

13. The system according to claim 12, wherein the circuitry is configured to retrieve similar strategy sequences from the vector database by computing cosine similarity scores between an embedding vector derived from the current resource allocation parameters and stored strategy sequence embedding vectors, and generate an explanation text for each retrieved similar strategy sequence for inclusion in the decision support data records.

14. The system according to claim 1, wherein the circuitry is configured to store decision support data records, corresponding prediction vectors, and scenario simulation outputs in an audit log data structure in the storage device with timestamps and session identifiers, and generate a model performance report from the audit log data structure by comparing historical prediction vectors against subsequently observed outcome data.

15. The system according to claim 1, wherein the circuitry is configured to execute a local cache update on a terminal device by transmitting a compressed subset of the most recently generated decision support data records to a local embedded database on the terminal device via the communication interface, and serve terminal device queries from the local cache when the terminal device is operating in an offline state.

16. The system according to claim 1, wherein the circuitry is configured to generate a dashboard data record from the prediction vectors, scenario simulation outputs, and decision support data records comprising time-series visualization data, scenario comparison charts, and ranked strategy displays, and transmit push notification data to terminal devices when a prediction vector dimension crosses a configurable alert threshold.

17. The system according to claim 1, wherein the heterogeneous data streams comprise time-series operational records from logistics processing facilities, the forecast dimensions of the prediction vectors correspond to throughput metrics, resource utilization metrics, and demand flow metrics, and the ranked strategy sequences in the decision support data records correspond to operational scheduling parameters and resource routing parameters.

18. A system comprising:
circuitry configured to:
receive, via a communication interface coupled to a packet-switched network, heterogeneous data streams from a plurality of data source endpoints and store the preprocessed data as a unified time-series tensor in a storage device;
apply a transformer-based time-series model comprising a self-attention mechanism to the unified time-series tensor to generate multi-step ahead prediction vectors with prediction confidence intervals;
generate scenario simulation outputs by conditioning the transformer-based time-series model on hypothetical condition parameter sets, and apply a graph neural network to a relationship graph of entity nodes to generate connectivity feature vectors for incorporation in prediction vector computation;
apply a generative neural network model to the prediction vectors and scenario simulation outputs to generate decision support data records comprising ranked strategy sequences with resource allocation parameters and risk evaluation scores; and
transmit the decision support data records to terminal devices via the communication interface.

19. The system according to claim 18, wherein the circuitry is configured to apply a self-learning update procedure to the deep learning model by extracting training examples from recently received data streams and corresponding validated outcome records, and generate a model performance report from an audit log data structure by comparing historical prediction vectors against subsequently observed outcome data.

20. A method comprising:
receiving, via a communication interface coupled to a packet-switched network, heterogeneous data streams from a plurality of data source endpoints, and storing the heterogeneous data streams in a storage device;
applying preprocessing operations comprising missing value imputation, standardization, normalization, and deduplication to the heterogeneous data streams, and integrating the preprocessed data into a unified time-series tensor structure indexed by time-series information and attribute identifiers;
applying a deep learning model to the unified time-series tensor to generate prediction vectors comprising future state probability distributions across a plurality of forecast dimensions, and generating scenario simulation outputs by applying the deep learning model conditioned on a plurality of hypothetical condition parameter sets;
generating decision support data records by applying a generative neural network model to the prediction vectors and the scenario simulation outputs, the decision support data records comprising ranked strategy sequences with associated resource allocation parameters; and
transmitting the decision support data records to terminal devices via the communication interface.
